(19) United States
(12) Patent Application Publication
(10) Pub. No.: US 2018/0054464 A1
(43) Pub. Date: Feb. 22, 2018

(54) METHOD AND SYSTEM FOR COLLABORATIVE INTELLIGENT VIRTUAL AGENTS

(71) Applicant: Rulai, Inc., Los Altos, CA (US)

(72) Inventors: Yi Zhang, Saratoga, CA (US); Xing Yi, Milpitas, CA (US); Huajun Zeng, Mountain View, CA (US); Jie Li, Cupertino, CA (US)

(21) Appl. No.: 15/677,275

(22) Filed: Aug. 15, 2017

Related U.S. Application Data
(63) Continuation-in-part of application No. 15/600,251, filed on May 19, 2017.
(60) Provisional application No. 62/375,765, filed on Aug. 16, 2016.

(51) Int. Cl. H04L 29/06; H04L 12/58

(52) U.S. Cl. CPC H04L 65/1096; H04L 67/30; H04L 51/02

(57) ABSTRACT

The present teaching relates to method, system, and medium of automatic re-routing a chat user in a dialog. A request is first received for re-routing the chat user, currently engaged in a dialog involving a first agent, to a second agent. The request comprises relevant information and context of the dialog that gives rise to the re-routing request. Based on the relevant information and the context of the dialog, a re-routing strategy is automatically determined in accordance with re-routing configurations. A second agent to which the chat user is to be re-routed to is then selected based on the re-routing strategy. The chat user is then re-routed to the second agent to continue the dialog.

### CROSS REFERENCE TO RELATED APPLICATION

This application is a continuation in part of U.S. application Ser. No. 15/600,251 filed May 19, 2017 and claims priority to U.S. Provisional Application 62/375,765 filed Aug. 16, 2016, all of which are hereby expressly incorporated by reference in their entireties.

### BACKGROUND

### 1. Technical Field

The present teaching generally relates to online services. More specifically, the present teaching relates to methods, systems, and programming for virtual agents.

### 2. TECHNICAL BACKGROUND

With the new wave of Artificial Intelligence (AI), some research effort has been directed to conversational information systems. Intelligent assistant or so called intelligent bot has emerged in recent years. Examples include Siri® of Apple, Facebook Messenger, Amazon Echo, and Google Assistant.

Conventional chat bot systems require many hand written rules and manually labelled training data for the systems to learn the communication rules for each specific domain. This led to expensive human-labeling efforts and, hence, high costs. In addition, developers of conventional chat bot systems are required to write and debug source codes themselves. There is no friendly and consistent interface for developers to design and customize virtual agents to meet their own specific needs, which causes each developer to face a long learning curve when developing a new virtual agent.

Therefore, there is a need to provide an improved solution for development and application of a virtual agent to solve the above-mentioned problems.

### SUMMARY

The teachings disclosed herein relate to methods, systems, and programming for online services. More particularly, the present teaching relates to methods, systems, and programming for developing a virtual agent that can have a dialog with a user.

In one example, a method implemented on a computer having at least one processor, a storage, and a communication platform for automatic re-routing a chat user in a dialog to a different agent. In this example, a request is first received for re-routing the chat user, currently engaged in a dialog involving a first agent, to a second agent. The request comprises relevant information and context of the dialog that gives rise to the re-routing request. Based on the relevant information and the context of the dialog, a re-routing strategy is automatically determined in accordance with re-routing configurations. A second agent to which the chat user is to be re-routed to is then selected based on the re-routing strategy. The chat user is then re-routed to the second agent to continue the dialog.

In a different example, a system for developing a virtual agent is disclosed to comprise a re-routing information analyzer, a re-routing strategy selector, and an agent re-routing controller. The re-routing information analyzer is configured for analyzing a request for re-routing the chat user, currently engaged in a dialog involving a first agent, to a second agent, wherein the request comprises relevant information and context of the dialog that gives rise to the re-routing request. The re-routing strategy selector is configured for determining automatically a re-routing strategy based on the relevant information and the context of the dialog, wherein the re-routing strategy is determined in accordance with re-routing configurations. The second agent is then selected based on the re-routing strategy. The agent re-routing controller configured for re-routing the chat user to the selected different agent to continue the dialog.

Other concepts relate to software for implementing the present teaching on developing a virtual agent. A software product, in accord with this concept, includes at least one machine-readable non-transitory medium and information carried by the medium. The information carried by the medium may be executable program code data, parameters in association with the executable program code, and/or information related to a user, a request, content, or information related to a social group, etc.

In one example, machine readable non-transitory medium is disclosed, wherein the medium has information stored thereon for automatic re-routing a chat user in a dialog to a different agent, wherein the information, when read by a machine, causes the machine to perform various operational steps, including receiving first a request for re-routing the chat user, currently engaged in a dialog involving a first agent, to a second agent. The request comprises relevant information and context of the dialog that gives rise to the re-routing request. Based on the relevant information and the context of the dialog, a re-routing strategy is automatically determined in accordance with re-routing configurations. A second agent to which the chat user is to be re-routed to is then selected based on the re-routing strategy. The chat user is then re-routed to the second agent to continue the dialog.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A depicts a framework of service agents development and application, according to an embodiment of the present teaching;

FIG. 1B illustrates exemplary service virtual agents, according to an embodiment of the present teaching;

FIG. 1C is a flowchart of an exemplary process for service agent development and application, according to an embodiment of the present teaching;

FIG. 2 depicts an exemplary high level system diagram of a service virtual agent, according to an embodiment of the present teaching;

FIG. 3A is a flowchart of an exemplary process of a service virtual agent, according to an embodiment of the present teaching;

FIG. 3B depicts an exemplary high level system diagram of semi-supervised learning mechanism, according to an embodiment of the present teaching;

FIG. 3C is a flowchart of an exemplary process of semi-supervised learning mechanism, according to an embodiment of the present teaching;

FIG. 3D depicts an exemplary scheme of generating seeds for semi-supervised learning, according to an embodiment of the present teaching;

FIG. 3E illustrates exemplary FAQ models from semi-supervised learning, according to an embodiment of the present teaching;

FIG. 3F illustrates exemplary task-based models from semi-supervised learning, according to an embodiment of the present teaching;

FIG. 4A depicts an exemplary high level system diagram of a dynamic dialog state analyzer in a service virtual agent, according to an embodiment of the present teaching;

FIG. 4B is a flowchart of an exemplary process for a dynamic dialog state analyzer in a service virtual agent, according to an embodiment of the present teaching;

FIG. 5A depicts an exemplary high level system diagram of a real-time task manager, according to an embodiment of the present teaching;

FIG. 5B is a flowchart of an exemplary process of a real-time task manager, according to an embodiment of the present teaching;

FIG. 6A depicts an exemplary high level system diagram of an agent re-router in a service virtual agent, according to an embodiment of the present teaching;

FIG. 6B is a flowchart of an exemplary process of an agent re-router in a service virtual agent, according to an embodiment of the present teaching;

FIG. 7A illustrates exemplary types of re-routing conditions and configurations, according to an embodiment of the present teaching;

FIG. 7B depicts an exemplary high level system diagram of a re-routing strategy selector, according to an embodiment of the present teaching;

FIG. 7C is a flowchart of an exemplary process of a re-routing strategy selector, according to an embodiment of the present teaching;

FIG. 8 illustrates an exemplary user interface during a dialog between a service virtual agent and a chat user, according to an embodiment of the present teaching;

FIG. 9 illustrates an exemplary user interface during dialogs between a service virtual agent and multiple chat users, according to an embodiment of the present teaching;

FIG. 10 depicts an exemplary high level system diagram of a virtual agent development engine, according to an embodiment of the present teaching;

FIG. 11 is a flowchart of an exemplary process of a virtual agent development engine, according to an embodiment of the present teaching;

FIG. 12 illustrates an exemplary bot design programming interface for a developer to input conditions for triggering a dialog between a service virtual agent and a chat user, according to an embodiment of the present teaching;

FIG. 13A illustrates an exemplary bot design programming interface for a developer to select modules of a service virtual agent, according to an embodiment of the present teaching;

FIG. 13B illustrates an exemplary bot design programming interface through which a developer selects some parameter for a module of a service virtual agent, according to an embodiment of the present teaching;

FIG. 13C illustrates an exemplary bot design programming interface through which a developer modifies some parameter for a module of a service virtual agent, according to an embodiment of the present teaching;

FIG. 14 is a high level depiction of an exemplary networked environment for development and applications of service virtual agents, according to an embodiment of the present teaching;

FIG. 15 is a high level depiction of another exemplary networked environment for development and applications of service virtual agents, according to an embodiment of the present teaching;

FIG. 16 depicts the architecture of a mobile device which can be used to implement a specialized system incorporating the present teaching; and

FIG. 17 depicts the architecture of a computer which can be used to implement a specialized system incorporating the present teaching.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The present disclosure generally relates to systems, methods, medium, and other implementations directed to various aspects of technologies associated with technologies used in artificial intelligence based human-machine interactions. In some embodiments, semi-supervised approaches are disclosed for learning from past and present conversations in order to efficiently and effectively derive different types of dialog models, including FAQ models and task-based conversation models. In a different embodiment, to handle dynamically changing contexts in human-machine conversations, present teaching also discloses means to automatically selecting and switching resources, adaptive to the dynamic conversation contexts, in order to appropriately support the changing dialogs. The adaptive selection and switching resources may include switching from one agent to another agent based on dynamically developed conversation situations, whether from a virtual agent to a different virtual agent or to a human agent, in accordance with what is called for.

In other embodiments, the present teaching discloses developing, training, and deploying effective intelligent virtual agents. In different embodiments, the present teaching discloses a virtual agent that can have a dialog with a user, based on a bot design programming interface. Conventionally, bot design involves primarily human activities, relying on human service representatives to design information needs associated with their customers, including what questions to be asked to gather what types of information, designing procedures to help customers to perform certain account management tasks, designing strategies for making different types of recommendations for products to users/services/information in certain situations. In order to effectively reduce the human labor and cost of developing/designing those service agents which offer and maintain real-time online user service dialogue systems, the present teaching discloses methods for designing and developing intelligent virtual agents, which can automatically generate and recommend response/reply messages for assisting human representatives or acting as virtual representatives/agents to communicate with customers in a more efficient and effective way, to achieve similar or even better customer satisfaction with minimum human involvement.

The present teaching can enable online dialogue systems to generate high quality responses by effectively leveraging and learning from different types of information via different technologies, including artificial intelligent (AI), natural language processing (NLP), ranking based machine learning, personalized recommendation and user tagging, multimedia sentimental analysis and interaction, and reinforcement based learning. For example, the key information utilized may include: (1) natural language conversation history/data logs from all users, (2) conversation contextual information such as the conversation history of a current session, the time and the location of the conversation, (3) the current user's profile, (4) knowledge specific with respect to each different service as well as each specific industry domain, (5) knowledge about internal or external third party informational services, (6) user click history and user transaction history, as well as (7) knowledge about customized conversation tasks.

The disclosed system in the present teaching can integrate various intelligent components into one comprehensive online dialogue system to generate high-quality automatic responses for effectively assisting human representatives/agents to accomplish complex service tasks and/or address customer's information need in an efficient way. More specifically, based on machine learning and AI technique, the disclosed system can learn how to strategically ask user questions, present intermediate candidates to the users based on historical human-human or human-machine or machine-machine conversation data, together with human or machine action data that involves calling third party applications, services or databases. The disclosed system can also learn and build/enlarge high quality answer knowledge base by identifying important frequent questions from historical conversational data and proposing new identified FAQs and their answers to be added to the knowledge base, which may be reviewed by human agents. The disclosed system can use the knowledge base and historical conversations for recommending high quality response messages for future conversation. The present teaching has disclosed both statistical learning and template based approach as well as deep learning models (e.g. a sequence to sequence language generation model, a sequence to structured data generation model, a reinforcement learning model, a sequence to user intention model) for generating higher quality and better utterance/response messages for the conversation and interaction. Moreover, the disclosed system can provide more effective products/services recommendations in the conversation by using not only user transaction history and user demographic information that are normally used in traditional recommendation engines, but also additional contextual information about the user needs, such as possible user initial request (i.e. a user query) or supplemental information collected while talking with the user. The disclosed system is also capable of using those information as well as users' implicit feedback signals (such as clicks and conversions) when interacting with our recommendation results to more effectively learn users' interests, persuade them for certain conversions, collect their explicit feedback (such as rating), as well as actively solicit additional sophisticated user feedback such as their suggestions for future product/service improvement.

The terms “service virtual agent”, “virtual agent”, “conversational agent”, “agent”, “bot” and “chat bot” may be used interchangeably herein.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

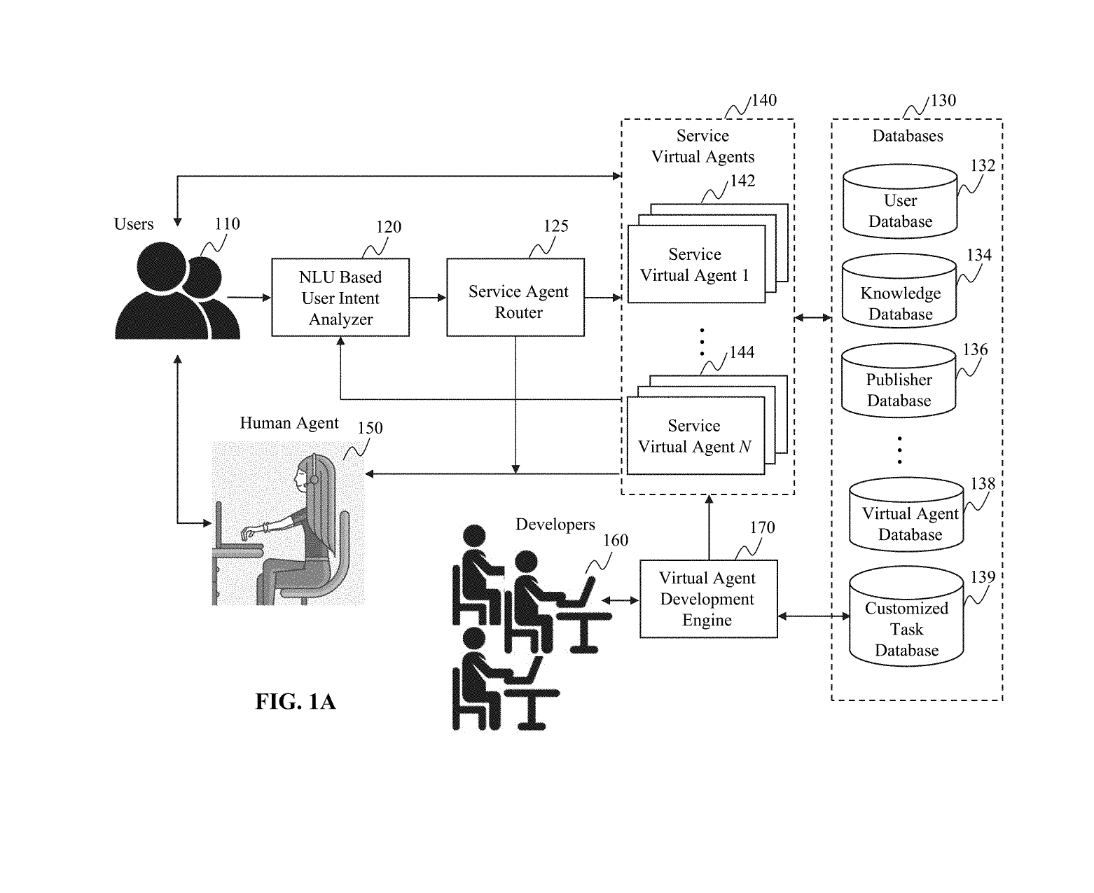

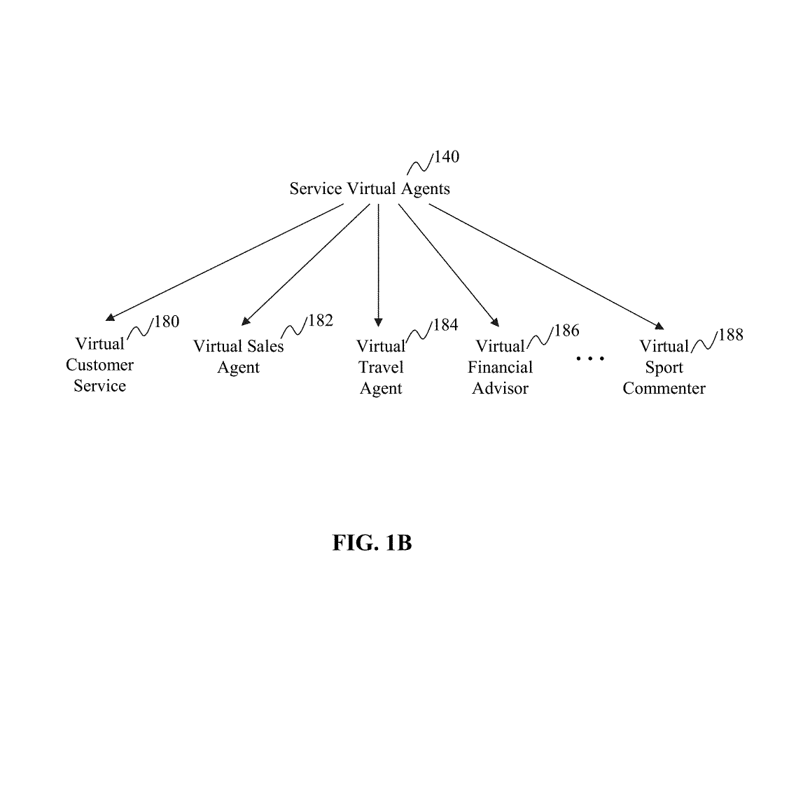

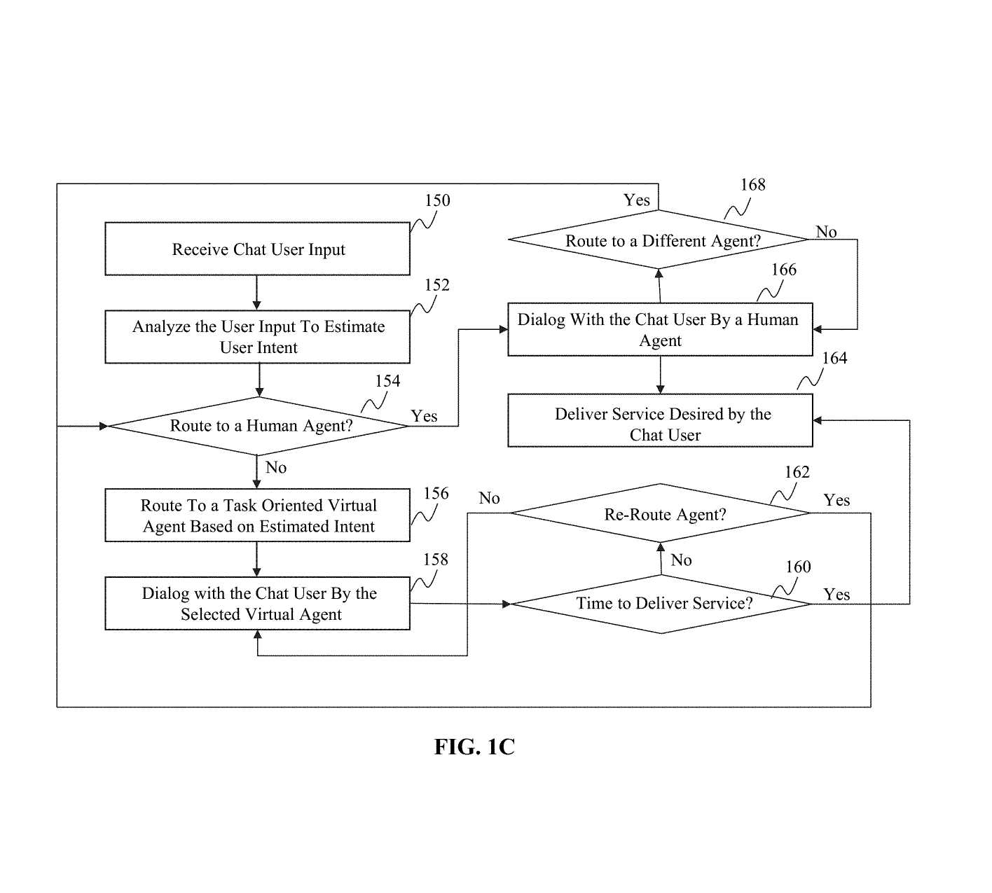

FIG. 1A depicts a framework of the development and applications of service virtual agents, according to an embodiment of the present teaching. In this example, the disclosed system may include an NLU (natural language understanding) based user intent analyzer 120, a service agent router 125, N service virtual agents 140, databases 130, and a virtual agent development engine 170.

The service virtual agents 140 in FIG. 1A may perform direct dialogs with the users 110. Each virtual agent may focus on a specific service or domain when chatting with one or more users. For example, a user may send utterances to the NLU based user intent analyzer 120. Upon receiving an utterance from a user, the NLU based user intent analyzer 120 may analyze the user's intent based on an NLU model and the utterance. In one embodiment, the NLU based user intent analyzer 120 may utilize machine learning technique to train the NLU model based on real and simulated user-agent conversations as well as contextual information of the conversations. The NLU based user intent analyzer 120 may estimate the user intent and send the estimated user intent to the service agent router 125 for agent routing.

The service agent router 125 in this example may receive the estimated user intent from the NLU based user intent analyzer 120 and determine one of the service virtual agents 140 based on the estimated user intent. FIG. 1B illustrates exemplary service virtual agents, according to an embodiment of the present teaching. For example, as shown in FIG. 1B, a service virtual agent may be a virtual customer service 180, a virtual sales agent 182, a virtual travel agent 184, a virtual financial advisor 186, or a virtual sport commenter 188, etc.

Referring back to FIG. 1A, once the service agent router 125 determines that a service virtual agent has a domain or service matching the estimated user intent, the service agent router 125 can route the user's utterance to the corresponding virtual agent to enable a conversation between the virtual agent and the user.

During the conversation between the virtual agent and the user, the virtual agent can analyze dialog states of the dialog and manage real-time tasks related to the dialog, based on data stored in various databases, e.g. a knowledge database 134, a publisher database 136, and a customized task database 139. The virtual agent may also perform product/service recommendation to the user based on a user database 132. In one embodiment, when the virtual agent determines that the user's intent has changed or the user is unsatisfied with the current dialog, the virtual agent may redirect the user to a different agent based on a virtual agent database 138. The different agent may be a different virtual agent or a human agent 150. For example, when the virtual agent detects that the user is asking for a sale related to a large quantity or a large amount of money, e.g. higher than a threshold, the virtual agent can escalate the conversation to the human agent 150, such that the human agent 150 can take over the conversation with the user. The escalation may be seamless and not causing any delay to the user.

The virtual agent development engine 170 in this example may develop a customized virtual agent for a developer via a bot design programming interface provided to the developer. The virtual agent development engine 170 can work with multiple developers 160 at the same time. Each developer may request a customized virtual agent with a specific service or domain. As such, a service virtual agent, e.g. the service virtual agent 1 142, may have different versions as shown in FIG. 1A, each of which corresponds to a customized version generated based on a developer's specific request or specific parameter values. The virtual agent development engine 170 may also store the customized tasks into the customized task database 139, which can provide previously generated tasks as a template for future task generation or customization during virtual agent development.

FIG. 1C is a flowchart of an exemplary process for service agent development and application, according to an embodiment of the present teaching. When an input is received from a chat user at 150, the input from the chat user is analyzed, at 152, to estimate the intent of the chat user. It is then determined, at 154 based on the estimated intent, whether the chat user should be directed to a human or virtual agent. If the chat user is directed to a human agent, the process proceeds to 166 where the dialog with the chat user is conducted with a human agent. The dialog with the human agent may continue until a service is delivered, at 164, to the chat user. The human agent may also assess from time to time during the dialog, at 168, whether there is a need to route the chat user to a different agent, either virtual or human. If no, the conversation continues at 166. If there is a need to route the chat user to other agent, the process proceeds to 154, where it is determined whether to route to a (different) human agent or a virtual agent. Once the new conversation is initiated with a different agent, the process proceeds to 150.

If a decision is made, at 154, to use a virtual agent to carry out a dialog with a chat user, a task oriented virtual agent is selected, at 156, based on, e.g., the estimated intent of the chat user. For example, if it is estimated that a chat user's intent is to look for flight information, the chat user may be routed to a travel virtual agent designed to specifically handle tasks related to flight reservations. If a chat user's intent is estimated to be related to car rental, the chat user may accordingly be routed to a rental car virtual agent. The selected virtual agent and the chat user proceed with the dialog at 158. Similarly, during the dialog, the virtual agent attempts to ascertain what the chat user is seeking and the ultimate goal is to deliver what the chat user desires.

During the dialog between a virtual agent and a chat user, it may be routinely assessed, at 160, whether it is time to deliver information/service to the chat user. If it is determined, at 160, that it is time to deliver the desired service to the chat user, the service/information is delivered to the chat user at 164. If it is determined at 162 that the virtual agent still cannot determine what the chat user desires, it is assessed, at 162, whether the chat user needs to be routed to a different agent, either human or virtual. The assessment may be based on different criteria. Examples include that the chat user somewhat seems unhappy or upset, that the dialog has been long without a clear picture what the chat user wants, or that what the chat user is interested in is not what the virtual agent can handle. If it is determined not to re-route, the process proceeds back to 158 to continue the dialog. Otherwise, the process proceeds to 154 to decide whether the chat user is to be re-routed to a human agent or a (different) virtual agent.

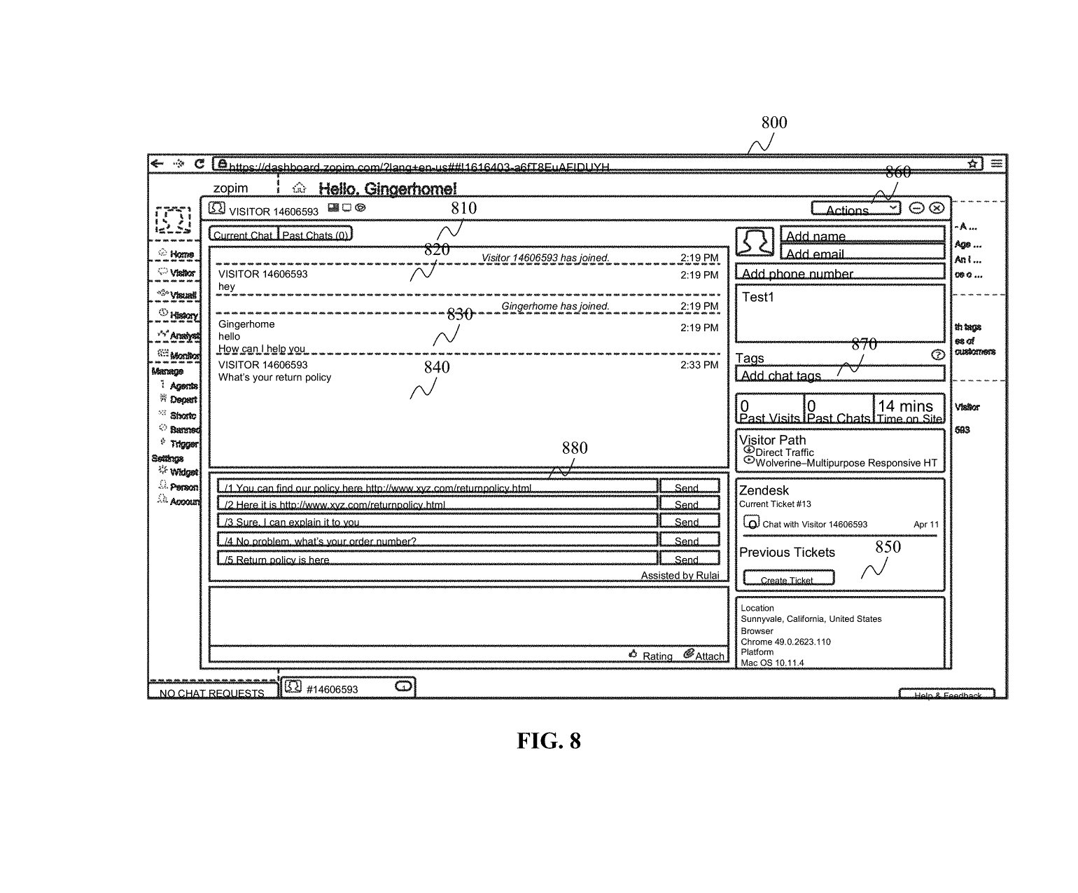

Another aspect of the present teaching relates to the virtual agent development engine 170, which enables bot design and programming via graphical objects by integrating modules via drag and drop of selected graphical objects with flexible means to customize. Details on this aspect of the present teaching are provided with reference to FIGS. 8-13C.

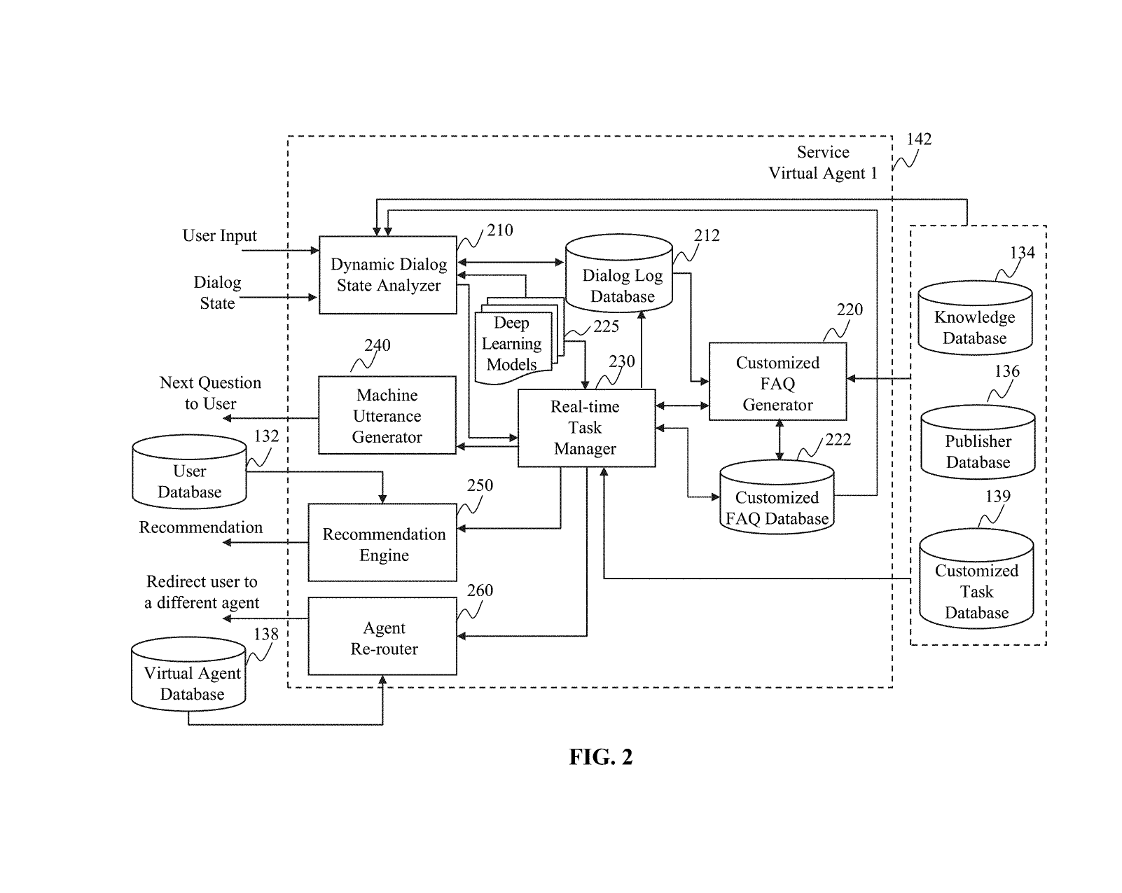

FIG. 2 depicts an exemplary high level system diagram of a service virtual agent 1 142, according to an embodiment of the present teaching. The service virtual agent 1 142 in this example comprises a dynamic dialog state analyzer 210, a dialog log database 212, one or more deep learning models 225, a customized FAQ generator 220, a customized FAQ database 222, various databased (e.g., a knowledge database 134, a publisher database 136, . . . , and a customized task database 139), a real-time task manager 230, a machine utterance generator 240, a recommendation engine 250, and an agent re-router 260.

In operation, the dynamic dialog state analyzer 210 continuously receives and analyzes the input from the user 110 and determines dialog state of the dialog with the user 110. The analysis of the user's input may be achieved via natural language processing (NLP), which can be a key component of the dynamic dialog state analyzer 210. Different NLP techniques may be employed to analyze the inputs from a user. The determination of a dialog state can be based on, e.g. deep learning models stored in 225 and optionally some known FAQs related to a customer from the customized FAQ database 222.

The dynamic dialog state analyzer 210 record dialog logs including both the dialog states and other metadata related to the dialog, into the dialog log database 212, which can be used by the customized FAQ generator 220 for further generating customized FAQs. The dynamic dialog state analyzer 210 may also estimate user intent based on the dialog state determined by analyzing the received user input. The estimated user intent is then sent to the real-time task manager 230 for real-time task management.

As discussed herein, in one embodiment, the dynamic dialog state analyzer 210 may analyze the user input based on customized FAQ data obtained from the customized FAQ database 222 generated by the customized FAQ generator 220. The customized FAQ generator 220 in this example may generate FAQ data customized for the domain associated with the service virtual agent 1 142, and/or customized based on a customers' specific requirements. For example, when the service virtual agent 1 142 is a virtual sales agent, the customized FAQ generator 220 may generate FAQs relevant to sales. Examples of FAQs customized for a sale agent include: What products are you selling? What is the price list for the products being sold? How can I pay for a product? How much is the shipping fee? How long will be the shipping time? Is there any local store? The customized FAQ generator 220 may generate these customized FAQs based on information from different sources such as the knowledge database 134, the publisher database 136, and the customized task database 139.

Information from different sources may provide knowledge of different perspectives for a virtual agent to utilize. For example, the knowledge database 134 may provide information about general knowledge related to products and services. The publisher database 136 may provide information about each publisher, e.g., products/services the publisher is selling for which companies, what advertisements of which products/services the publisher is displaying, or which service virtual agent 1 142 the publisher has deployed to provide services. The customized task database 139 may store data related to customized tasks generated according to some customers' specific requests. For example, if the service virtual agent 1 142 is a customized version of a virtual car sales agent developed based on a specific request for a location having a particular type of climate (e.g., many snow storms), the customized tasks database generated by the customized FAQ generator 220 may include FAQs customized specifically for that type of climate, e.g.: Do you like to add snow tires on your car? Which cars have all-wheel-drive functions? The answers to such questions may also be generated by the customized FAQ generator 222 based on, e.g., the information from the knowledge database 134. Such generated customized questions/answers may be stored in the customized FAQ database 222, which can then be retrieved by the dynamic dialog state analyzer 210 for understanding the user input and/or by the real-time task manager 230 for determining how to handle the questions from the user.

The questions/answers stored in the customized FAQ database 222 may also be used, by the customized FAQ generator 220 to generate more customized FAQs. For example, question “Which cars have all-wheel-drive functions?” may be asked in different ways, including “Do you have any car with all-wheel-drive function,” “How many cars do you have that have all-wheel-drive function?” Variations of a known question may be a basis for generating additional customized FAQ questions. The same can be applied to generating answers to different questions. In this way, the virtual agent automatically and adaptively continues to enhance its ability to handle more diversified questions.

The customized FAQ generator 220 may also generate customized FAQs based on data obtained from the dialog log database 212. For example, based on logs of previous dialogs between the service virtual agent 1 142 and various users, the customized FAQ generator 220 may identify which question is asked very frequently and which question is asked infrequently. Based the frequencies of the questions asked in the logs, the customized FAQ generator 220 may generate or update FAQs accordingly in the customized FAQ database 222. The customized FAQ generator 220 may also send the customized FAQ data to the real-time task manager 230 for determining next task type.

According to one embodiment of the present teaching, the disclosed system may also include an offline conversation data analysis component, which can mine important statistical information and features from historical conversation logs, human action logs and system logs. The offline conversation data analysis component, not shown, may be either within or outside the service virtual agent 1 142. The important statistical information and signals (e.g. the frequency of each types of question and answer, and the frequency of human-edits for each question, etc.) can be used by other system components (such as the customized FAQ generator 220 for identifying important new FAQs, and the recommendation engine 250 for performing high-quality recommendations for products and services,) for their addressed specific tasks for the disclosed system.

The real-time task manager 230 in this example may receive estimated user intent and dialog state data from the dynamic dialog state analyzer 210, customized FAQ data from either the customized FAQ database 222 or directly from the customized FAQ generator 220, and/or information from the customized task database 139. Based on the dialog state, the FAQ data, the real-time task manager 230 may determine a next task for the service virtual agent 1 142 to perform. Such decisions may be made based also on information or knowledge from the customized task database 139. For example, if an underlying task is to assist a chat user to find weather information of a locale, the knowledge from the customized task database 139 for this particular task may indicate that the virtual agent or bot for this task needs to collection information about the locale (city), date, or even time in order to proceed to get appropriate weather information. Similarly, if the underlying task is for assisting a chat user to get a rental car, the knowledge or information stored in the customized task database 139 may provide guidance as to what information a virtual agent or bot needs to collect accordingly from the chat user. For example, for the task of identifying a rental car for a user, the information that needs to be collected may involve pick-up location, drop-off location, date, time, name of the user, driver license (optional), type of car desired, price range, etc. Such information may be fed to the real-time task manager 230 to determine what questions to ask a chat user.

According to some embodiment of the present teaching, a next action can be an action or a different task, selected from multiple types of actions or tasks. For example, an action may be to continue to solicit additional input from the user (in order to narrow down the specific interest of the user) by asking appropriate questions. Alternatively, an action may also be to proceed to identify an appropriate product to be recommended to the user, e.g., when it is decided that the user input at that point is adequate to ascertain the intent. The next action may also be to proceed to a different task. For instance, during a session of conversation related to booking a flight, a user may ask to book a hotel room in the destination city. In this case, the next action is to proceed to a different task (which may be handled by a different agent, whether human or virtual agent) to take care of the user's need for making a reservation of a hotel room.

Furthermore, the real-time task manager 230 may be operating in a space that includes both a machine action sub-space and a human action sub-space. In the machine action sub-space, tasks/actions are handled by virtual agents. In the human action sub-space, actions/tasks are handled by human agents. The actions/tasks related to a dialog session may be channeled within the same sub-space or across the two sub-spaces. For instance, a virtual agent in the machine sub-space may invoke another virtual agent in the same machine sub-space, determined based on, e.g., the context of the dialog, the detected user intent, and/or the specialty of other virtual agents. As another example, an action taken by a virtual agent in the machine sub-space may be to re-route to a human agent in the human sub-space and vice versa. The channeling between the two sub-spaces may be controlled based on models established via machine learning. According to the present teaching, the real-time task manager 230 may determine which action to take based on deep learning models stored in 225 and data obtained from the knowledge database 134, the publisher database 136, and the customized task database 139.

When the real-time task manager 230 decides to continue the conversation with the user to gather additional information, the real-time task manager 230 also determines the appropriate next question to ask the user. Then the real-time task manager 230 may send the question to the machine utterance generator 240 for generating machine utterances corresponding to the question. The machine utterance generator 240 may generate machine utterances corresponding to the question to be presented to the user and then present the machine utterances to the user. The generation of the machine utterances may be based on textual information or oral using, e.g., text to speech technology.

When the real-time task manager 230 determines that there has been adequate amount of information gathered to identify an appropriate product or service for the user, the real-time task manager 230 may then proceed to invoke the recommendation engine 250 for searching an appropriate product or service to be recommended.

The recommendation engine 250, when invoked, searches for product appropriate for the user based on the conversation with the user. In searching for a recommended product, in addition to the user intent estimated during the conversation, the recommendation engine 250 may also further individualize the recommendation by accessing the user's profile from the user database 132. In this manner, the recommendation engine 250 may individualize the recommendation based on both user's known interest (from the user database 132) and the user's dynamic interest (from the conversation). The search may yield a plurality of products and such searched product may be ranked based on a machine learning model.

When the real-time task manager 230 determines that the conversation with the user involves a price that is higher than a threshold, or that the user has a new intent associated with a domain requiring expertise other than that of the service virtual agent 1 142, or that the user is detected in a dissatisfaction mood, the real-time task manager 230 may then invoke the agent re-router 260 for re-routing the user to a different agent. The agent re-router 260, when invoked, may re-route the user to a different agent. Depending on the context of the conversation, the re-routing agent is selected. For example, the agent re-router 260 may route the user to a different service virtual agent, when it is detected that what the user needs requires expertise of the different service virtual agent.

In a different situation, the agent re-router 260 may re-route the user to the human agent 150, when, e.g., the conversation with the user indicates a situation that requires human agent involvement. Such a situation may be pre-defined or dynamically detected. For example, if the conversation leads to an intended transaction that involves a sum of money higher than a threshold, the further handling may be re-routed to a human agent. As another example, during the conversation, it may be detected (dynamically) that the user is dissatisfied with the service virtual agent 1 142. In this case, the service virtual agent 1 142 may re-route the user to a human agent. Similarly, if at any time, the service virtual agent 1 142 is incapable of gathering needed information (e.g., stuck in a situation in which either the user is not providing the needed information or whatever the user provided is not comprehensible by the service virtual agent) to advance the conversation, the user may also be re-routed to a human agent. In yet another case, the agent re-router 260 may re-direct the user's conversation to the NLU based user intent analyzer 120 to perform the NLU based user intent analysis again and to re-route the user to a corresponding virtual agent, when e.g. the service virtual agent 1 142 detects that the user has a new intent associated with a different domain than that of the service virtual agent 1 142 but cannot determine which virtual agent corresponds to the same domain as the new intent.

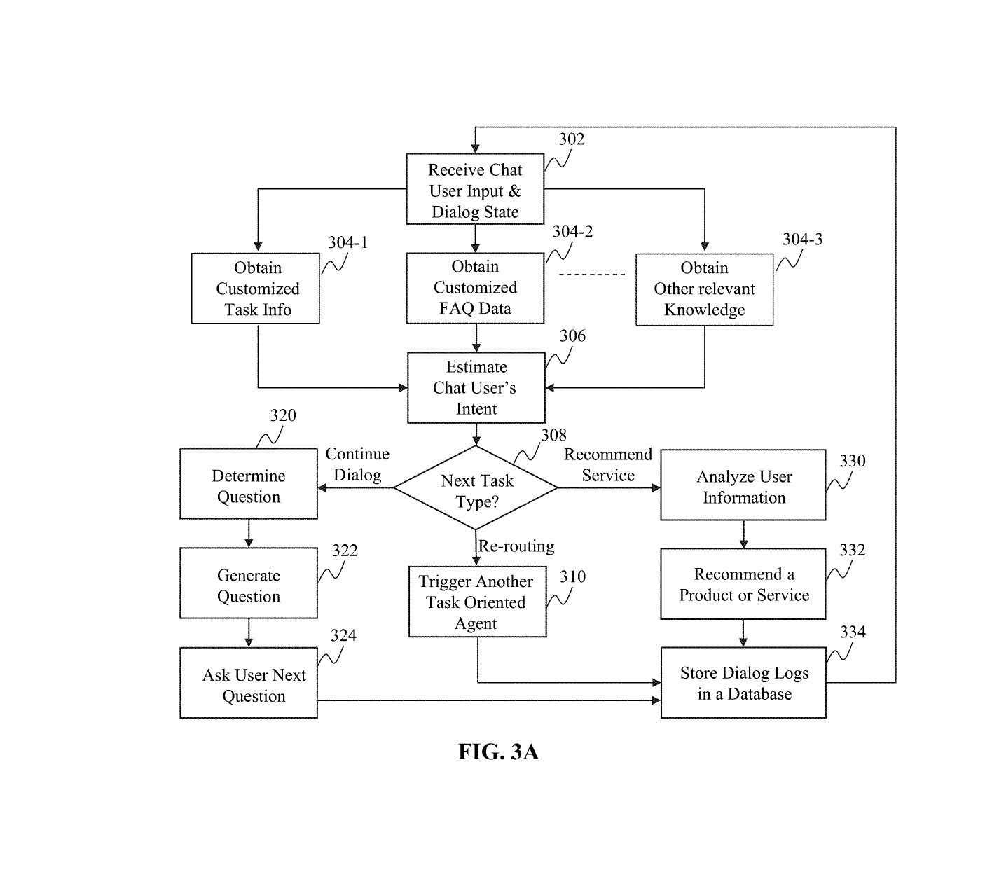

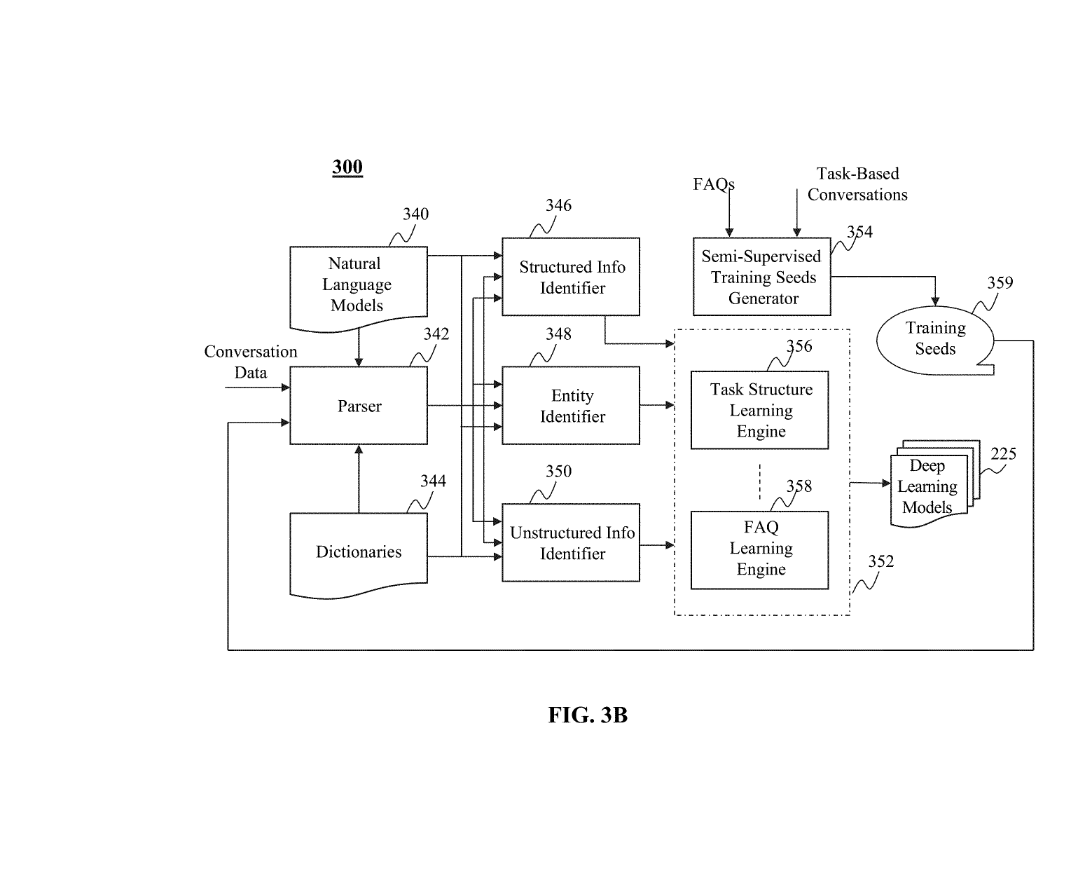

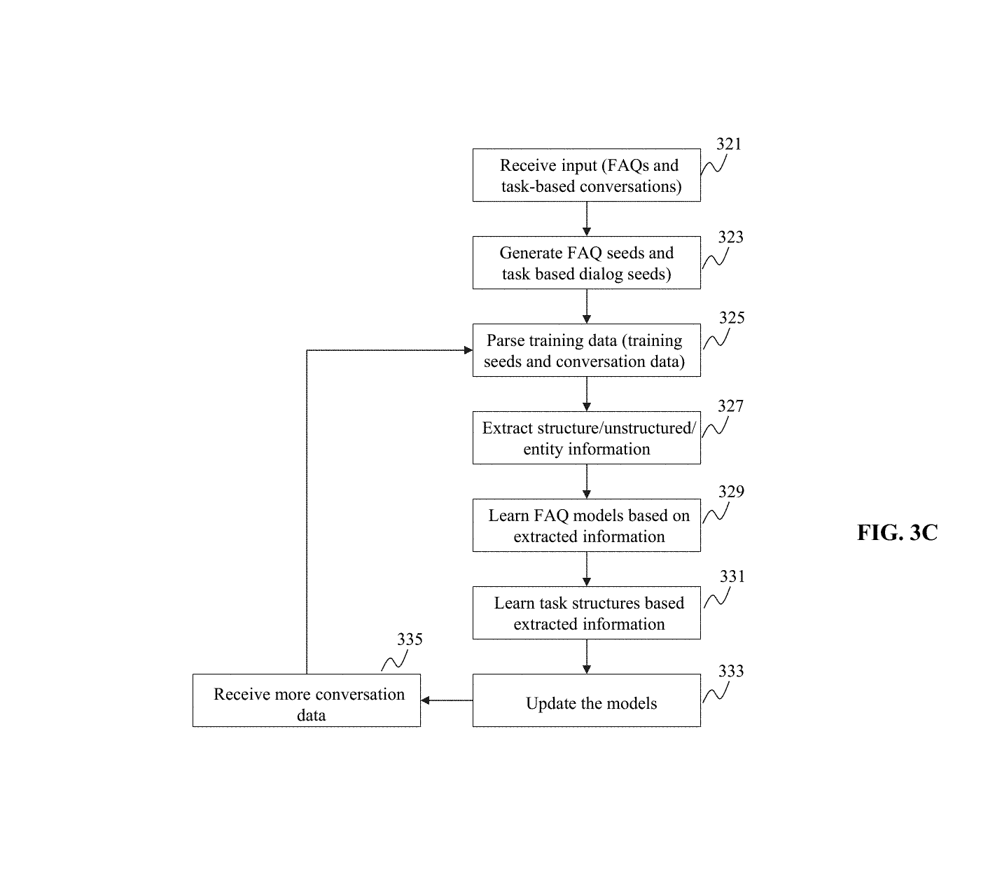

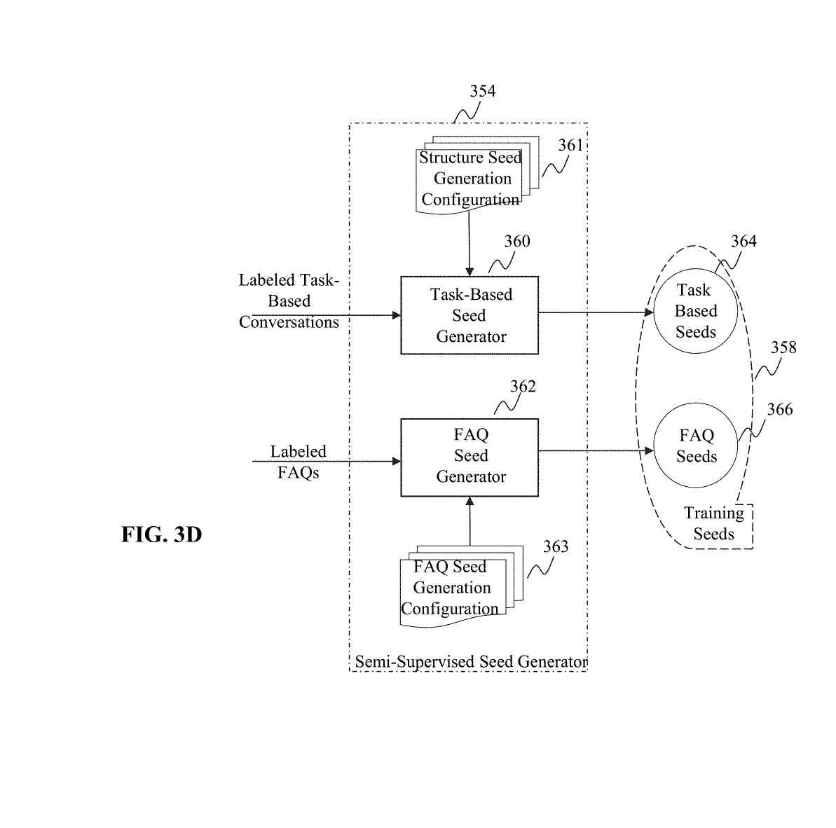

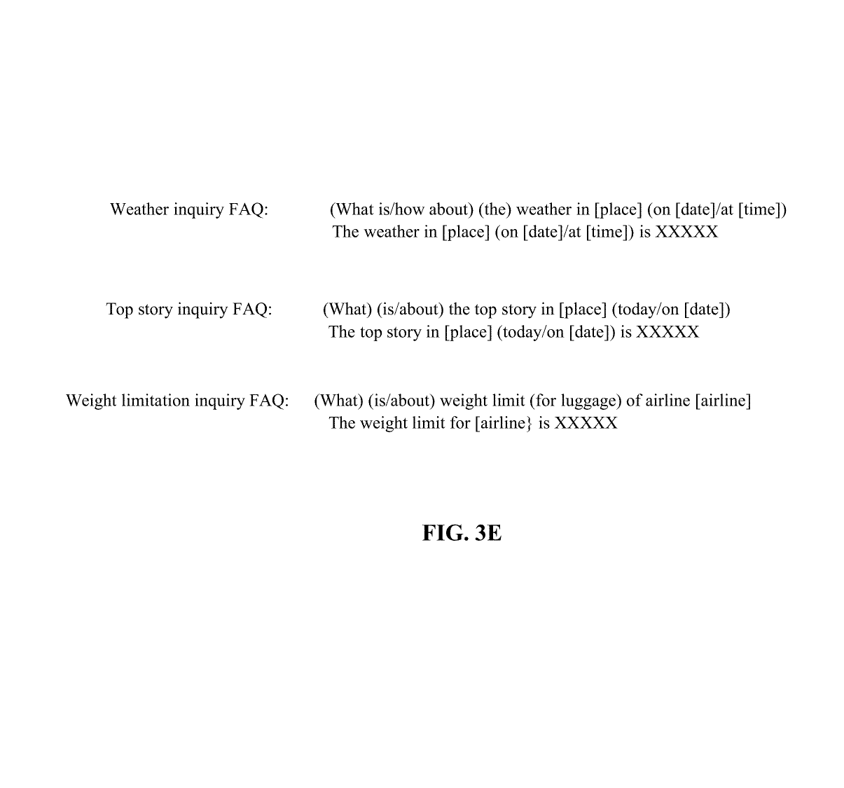

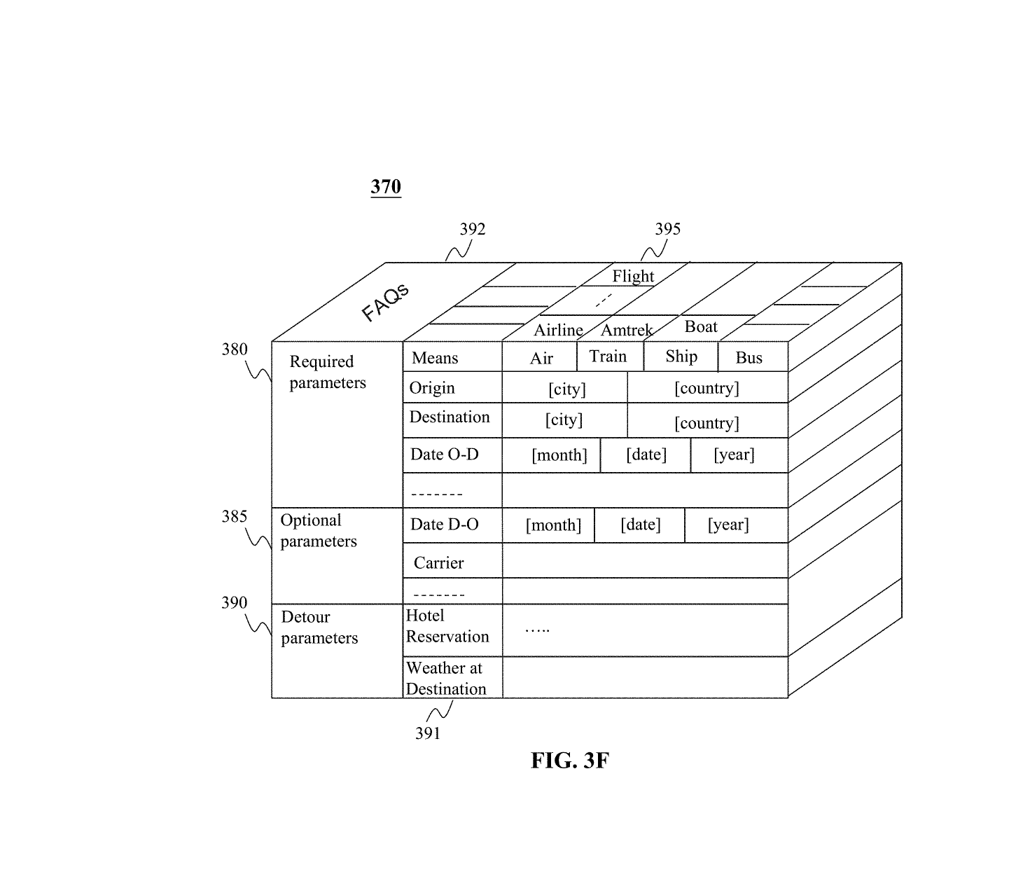

FIG. 3A is a flowchart of an exemplary process of a service virtual agent, e.g. the service virtual agent 1 142 in FIG. 2, according to an embodiment of the present teaching. At 302, a user input and/or dialog state are received. The input can be either the initial input from the user or an answer from the user provided in response to a question posted by the service virtual agent 1 142. Various types of relevant information may then be obtained at 304, which includes customized task information related to customers at 304-1, customized FAQ data at 304-2, . . . , and other types of relevant knowledge/information at 304-3. The received different types of information are then analyzed to estimate chat user's intent at 306. For example, customized FAQ data and customized task information may be utilized to detect the intent of the chat user. The intent may be gradually estimated based on the dialog state which is continuously built up based on received input from the chat user. At 308, the real-time task manager 230 determines what the next task type is based on the current estimated dialog state.

If the next task type is determined at 308 to continue the question to carry on the conversation, the process goes to 320 to determine the next question to ask the user. At 322, the question is generated in an appropriate form with some utterances. Then the question is asked at 324 to the user. Then the process goes to 334 for storing dialog logs in a database.

If the next task type is determined at 308 to recommend a product or service to the user, the recommendation engine 250 is invoked to analyze, at 330, the user information from the user database 132 and recommends, at 332, one or more products or services that match the dynamically estimated user intent (interest) and/or the user information. Then the process goes to 334 for storing dialog logs in a database.

If the next task type is determined at 308 to re-route the chat user, the process goes to 310 to re-route the user to a different agent. The different agent may be a different virtual agent having a domain that is same or similar to the user's newly estimated intent. The different agent may also be a human agent when the user is detected to be involved in a high-price transaction or be unsatisfied with the current virtual agent. Then the process goes to 334 for storing dialog logs in a database.

FIG. 3B depicts an exemplary high level system diagram of a semi-supervised learning mechanism 300, according to an embodiment of the present teaching. The semi-supervised learning mechanism 300 is provided to obtain the deep learning models 225 via semi-supervised learning and comprises a parser 342, a structured information identifier 346, an entity identifier 348, an unstructured information identifier 350, a semi-supervised training seeds generator 354, and a learning engine 352. In operation, the parser 342 takes conversation data from actual dialogs with users and training seeds 359 (generated by the semi-supervised training seeds generator 354 as input. Based on natural language models 340 and dictionaries 344, the parser 342 parses the input conversations and sends such processed results to various identifiers to extract relevant information.

The structured information identifier 346 may process the parsed conversation information from the parser 342 to extract structured information. Similarly, the entity identifier 348 processes the parsed conversation information from the parser 342 and extracts entity information. The unstructured information identifier 350 extracts unstructured information from the processed conversation information from the parser 342. Such different types of extracted information are then sent to the learning engine 352 as training data to obtain different trained models. The learning may be directed to different aspects of the conversations.

In FIG. 3B, examples are shown that the learning engine 352 includes a task structure learning engine 356, . . . , and an FAQ learning engine 358. Each specific learning engine (356, . . . , 358) is designed to learn some specific aspect(s) and the result may corresponding to a set of models directed to the specific aspect(s) of the deep learning models for conversations.

In some embodiments, the FAQ learning engine 358 may be designed to learn, from both training seeds 354 and the conversation data, FAQ models that represent different ways to ask the same questions. As illustrated above, each question may be asked using different language styles or varying ways. For example, question “Which cars have all-wheel-drive functions?” may be asked in different ways, including “Do you have any car with all-wheel-drive function,” “How many cars do you have that have all-wheel-drive function?” These different variations are to be recognized as asking the same question, based on which a service virtual agent may accordingly determine how and what is to be used to answer the question. Learning different ways to say the same thing may then allow a service virtual agent to adapt to different users.

FAQs correspond to one round of conversation (question and answer). FAQ models are to capture the variations of one round conversation. FIG. 3E illustrates exemplary FAQ models from semi-supervised learning, according to an embodiment of the present teaching. In this illustration, three exemplary learned FAQ models are provided: (1) one is related to an inquiry about weather, (2) the second is an inquiry about the top story, and (3) an inquiry about weight limit applied by an airline during a flight. In this illustration, each FAQ model is a pair, with one question and one answer. For example, the question of the learned FAQ model for inquiring about weather is “(what is/how about) (the) weather in [place] (on [date]/at [time])” and the answer for this inquiry is “The weather in [place] (on [date]/at [time]) is ______.” In this exemplary learned model, content in the parentheses ( ) is optional, content in brackets [ ] is a placeholder, slash “/” indicates alternatives, etc. The plain text may then represent necessary text for asking for weather information. Based on this model, to inquire about the weather, the necessary content is “weather in [place]” and all other content is optional. For instance, an inquiry can be “what is the weather in Seattle on Jul. 24, 2017,” “how about the weather in New York,” “weather in Ashburn at 10:00 am,” etc. That is, this exemplary FAQ model captures variations of inquiring about weather. Similarly, the exemplary FAQ model for inquiring about top story captures different ways to ask about the top story and the exemplary FAQ model for asking the weight limit of an airline captures alternative ways to inquire about it. Over time, when more conversation data are received and used for learning, the FAQ models may be further enhanced to include more ways to say the same thing.

The task structure learning engine 356 may be designed to learn, based on the training seeds 359 and the actual conversation data, structures associated with different tasks. A structure associated with a task may refer to the structure of different types of information needed to carry out the task. For example, for a weather agent to complete the task to provide weather information to a user, a structure associated with this task may specify the types of information that can be gathered to provide the weather information requested. Some of such types of information to be gathered may be necessary and some may be optional. For example, location is a piece of information that may be necessary in order to provide weather information, while information about time of day may not be necessary. As another example, for a task for making flight information, a structure for this task may indicate that necessary information to complete the task may include source, destination, choice of one-way or round trip, and date(s) of travel and that optional information may include price range, number of stops, etc.

The structure learned with respect to a specific task may also include indication of possible detours, representing where a user may diver to during a dialog related to the task. For instance, with respect to task of making a flight reservation, possible detours may include a task of making a hotel reservation, making a reservation at a restaurant, or checking sightseeing spots near the destination. In some embodiments, via possible detours, one task oriented structure (e.g., for task “book a flight”) may be linked to other task oriented structures (e.g., “reserve hotel,” “reserve restaurant,” and “tour guide.”). Such task oriented structures may be learned over time based on the training seeds 359 and the actual conversation data. The task structure learning engine 356 may learn such structures to obtain task oriented structure models and stores them in the deep learning models 225.

FIG. 3F illustrates exemplary task-based model 370 for booking a ticket obtained via semi-supervised learning, according to an embodiment of the present teaching. The learned task based structure 370 models the task of “booking a ticket” by specifying different types of information relevant to the task. As illustrated, the learned structure 370 indicates that information about some parameters associated with the underlying flight is required or necessary. This corresponds to “required parameters” 380. As shown, examples of information in this category include “means of travel” (which can be via air, train, ship, or bus), origin (which is specified by [city] and [country]), destination (also specified by [city] and [country]), and date from origin to destination (O-D) (which is specified as [month], [date], and [year]).

The learned structure 370 also indicates that information about some parameters is optional (385) and examples of information in this category include date to travel from destination to origin (D-O or round trip), carrier that conduct the transportation (e.g., airline if the means of travel is set as air travel), etc. In addition, the learned structure 370 may also specify possible detour parameters 390 (e.g., hotel reservation).

For each parameter (whether required, optional, or detour), there may be different alternatives (e.g., “means” includes alternatives “air,” “train,” “ship,” and “bus”) or different sub-parameters (e.g., [city] and [country] are sub-parameters of an origin or destination location and [month], [date], and [year] are sub-parameters of a date) specified as possible answers. Another dimension of the learned task-oriented model is that for each alternative or sub-parameters, there may be multiple FAQs associated therewith. For instance, the detour parameters 390 list one detour parameter as “Weather at destination” (391). There may be different ways to ask about weather, as discussed with reference to FIG. 3E. The FAQ model for inquiring about weather as illustrated in FIG. 3E may be associated with the “weather at destination” 391 in FIG. 3F. That is, to handle the inquiry in a task related to weather, the FAQ model for “weather” can be incorporated herein in the structure model that includes an inquiry about weather. As shown in FIG. 3F, the other dimension (third dimension) of model 370 corresponds to FAQs (392). Along this dimension, for each parameter (whether required, optional, or detour), there may be one or more FAQ models associated therewith modeling how dialog on this parameter may be gathered via one round conversation with the user. That is, to ascertain each parameter related to model 370, the learned model 370 captures (via FAG model) as to how to ask a question or provide an answer to gather the value of the parameter.

According to the present teaching, to train FAQ or task-based structure models, the semi-supervised training seeds generator 354 may generate the training seeds 359 which are then used for learning. In some embodiments, the training seeds correspond to labeled data. For example, FAQ training seeds may be labeled groups of sentences/phrases with each group containing sentences/phrases that are considered to say the same thing. For example, sentences “Which cars have all-wheel-drive functions,” “Do you have any car with all-wheel-drive function,” and “How many cars do you have that have all-wheel-drive function?” may be grouped together as different ways to ask whether the all-wheel-drive function is present. In another embodiment, a training seed to be used to learn the structure of task “book a flight” may correspond to a labeled dialog which includes conversation data related to a session in which a user booked a flight with an agent.

The semi-supervised training seeds generator 354 generates a set of labeled data as part of the training data serving as seeds for the learning. Providing a set of training seeds makes the learning process more efficient. At the same time, by providing training seeds without requiring the labor intensive labor to label all training data, it reduces the required effort/costs to generate labeled training data. The models obtained by the FAQ learning engine 358 and the task structure learning engine 356 are then stored as deep learning models 225, which will then be subsequently used by the real-time task manager 230 to determine how to carry out the task in hand.

In some embodiments, the models, including FAQ and tasks-based models, learned via semi-supervised learning scheme as disclosed herein, may be provided to experts for review, refinement, optimization, and/or approval. Such experts may include bot developers, customers (who engage the developers to design and create chat bots), or contractors who act on behalf of the developers or customers. During this process, e.g., the task-based models may be adjusted based on needs, FAQ models may be modified or supplemented so that such automatically learned models may be further enhanced to ensure quality. In this manner, not only the automated learning process can be expedited due to the deployment of the semi-supervised scheme but also the quality can be optimized due to the involvement of the customers. In this way, the customers or bot owners may exercise control in creating chat bots they desire.

FIG. 3C is a flowchart of an exemplary process of the semi-supervised learning mechanism 300, according to an embodiment of the present teaching. At 321, the semi-supervised training seeds generator 354 receives its input which includes FAQs and task-based conversations. Based on the received input, the semi-supervised training seeds generator 354 generates, at 323, FAQ seeds and task-based dialog seeds, respectively. Such generated training seeds are stored in 354. During learning, the parser 342 parses at 325, upon receiving training data, which include both the training seeds from 354 and the conversation data from actual conversations, the training data to generate parsed training data. The parsed training data are then sent to various identifiers to extract, at 327, structured/unstructured and entity information. Such extracted different types of data are then used by the learning engine 352 to learn, at 329, FAQ models and, at 331, task oriented structure models. The learned models are then used to update, at 333, the deep learning models 225. The learning process continues whenever additional conversation data are received at 335, or additional training seeds become available.

The semi-supervised training seeds generator 354 generates a set of labeled data as part of the training data serving as seeds for the learning. Providing a set of training seeds makes the learning process more efficient. At the same time, by providing training seeds without requiring the labor intensive labor to label all training data, it reduces the required effort/costs to generate labeled training data. FIG. 3D depicts an exemplary scheme of generating seeds for semi-supervised learning, according to an embodiment of the present teaching. In this illustrated embodiment, seeds for training FAQ models and that for training task-based structures are generated separately. As shown, the semi-supervised training seeds generator 354 comprises a task-based seed generator 360 and a FAQ seed generator 362. The task-based seed generator 360 receives labeled task-based conversations as input and generates task based training seeds 364, e.g., in accordance with a structure seed generation configuration 361. Similarly, the FAQ seed generator 362 takes labeled FAQs as input and generates FAQ seeds 366, e.g., in accordance with an FAQ seed generation configuration 363.

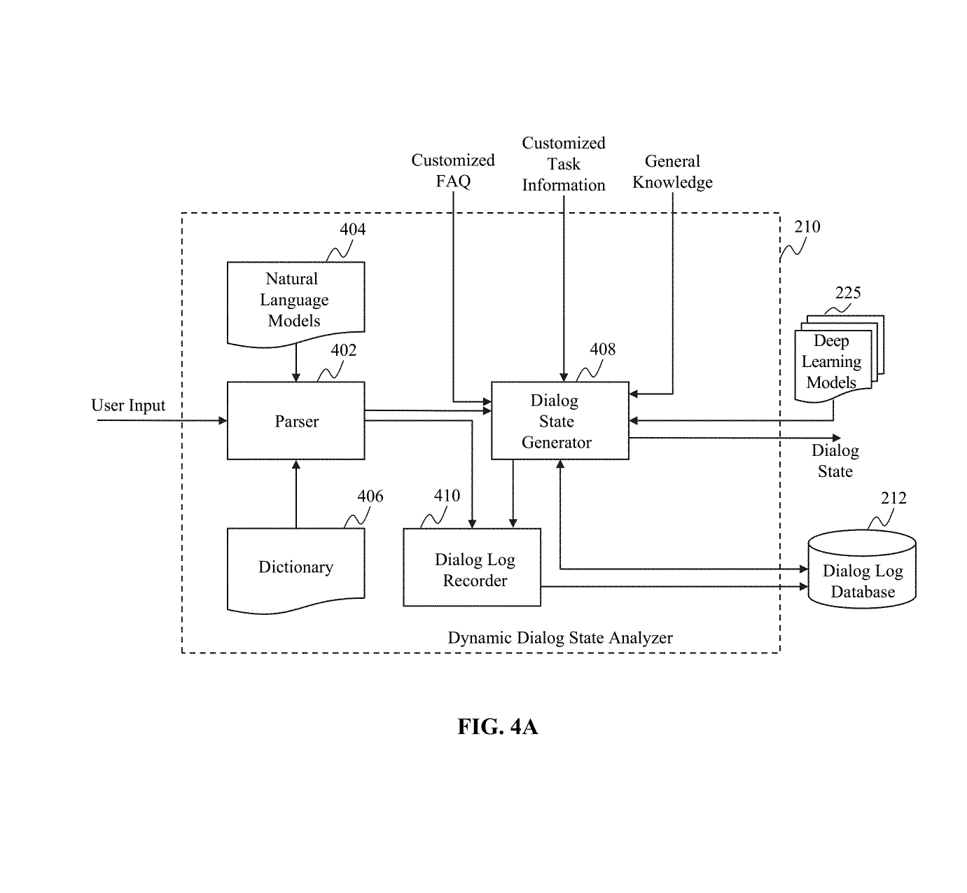

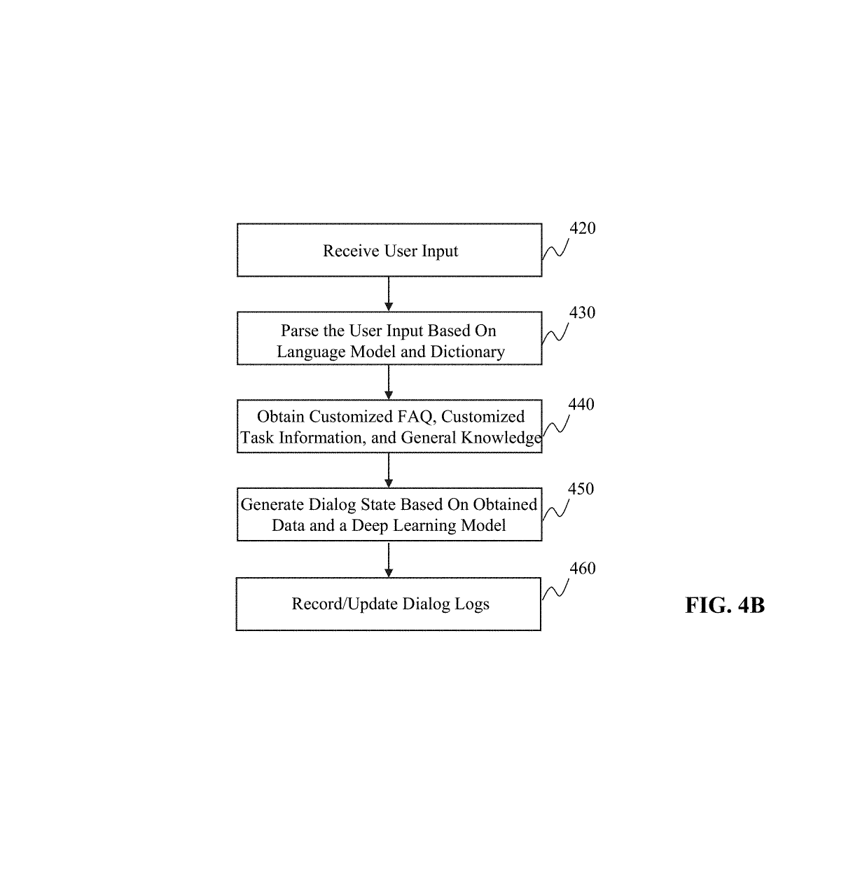

FIG. 4A depicts an exemplary high level system diagram of a dynamic dialog state analyzer 210 in a service virtual agent, e.g. the service virtual agent 1 142 in FIG. 2, according to an embodiment of the present teaching. The dynamic dialog state analyzer 210 can keep track of the dialog state of the conversation with the user and the user's intent based on continuously received user input. The dialog state and user intent are also continuously updated based on the new input from the user. As shown in FIG. 4, the dynamic dialog state analyzer 210 comprises a parser 402, one or more natural language models 404, a dictionary 406, a dialog state generator 408, and a dialog log recorder 410.

The parser 402 in this example may identify information from the user input that provides an answer to the question asked. For example, if the question is “Which brand do you prefer?” and the answer is “I love Apple,” then the parser is to extract “Apple” as the answer to “brand.”

The parser may incorporate NLU techniques, e.g., by employing a deep learning model to analyze a user utterance and extract values of the targeted product. The deep learning model may be trained based on weakly supervised learning mechanism. In the above example, the product may be “smartphone.” The parser 402 may process the user input based on the natural language models 404 and the dictionary 406, as shown in FIG. 4. Relevant information extracted from the user input by the parser 402 may be sent to the dialog state generator 408. The parser 402 may also send the extracted information to the dialog log recorder 410 for recording dialog logs.

Upon receiving the relevant information extracted from the user input, the dialog state generator 408 may generate or update a dialog state of the conversation based on the extracted relevant information. According to one embodiment of the present teaching, the dialog state generator 408 may obtain the customized FAQs from the customized FAQ generator 220, obtain customized task information from the customized task database 139, and obtain general knowledge from the knowledge database 134. Based on the obtained information, the dialog state generator 408 may generate or update a dialog state according to one of the deep learning models 225. For example, upon receiving all related answers of the user extracted from the user input regarding a selling product, the dialog state generator 408 may retrieve a dialog state from the dialog log database 212 and update the dialog state to indicate that the user is ready to buy the product, and it is time to provide payment method or platform to the user. In one embodiment, the dialog state generator 408 may retrieve historic dialog state of the user and concatenate historic dialog state with the current dialog state for the user. The dialog state generator 408 may send the generated or updated dialog state to the dialog log recorder 410 for recording dialog logs.

The dialog log recorder 410 in this example may receive both extracted information from the parser 402 and the dialog state information from the dialog state generator 408 related to the conversation. The dialog log recorder 410 may then record or update the dialog log for the conversation, and store it in the dialog log database 212.

FIG. 4B is a flowchart of an exemplary process for a dynamic dialog state analyzer in a service virtual agent, e.g. the dynamic dialog state analyzer 210 in FIG. 4, according to an embodiment of the present teaching. A user input is received first at 420, and is parsed, at 430, based on language models/dictionary. Customized FAQ, customized task information, and general knowledge are obtained at 440. Based on obtained data and a deep learning model, a dialog state is generated or updated at 450. At 460, the dialog logs including e.g. the dialog state and the extracted information from the user input, and other metadata related to the conversation, are recorded or updated.

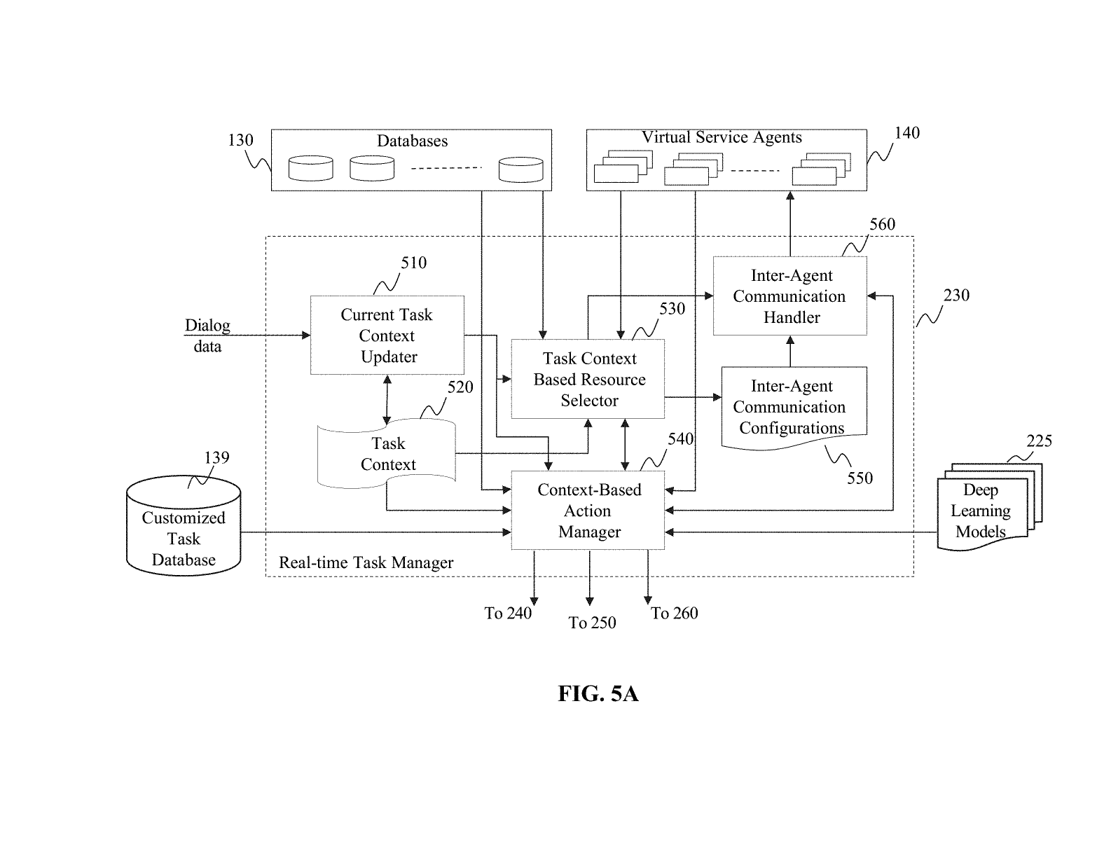

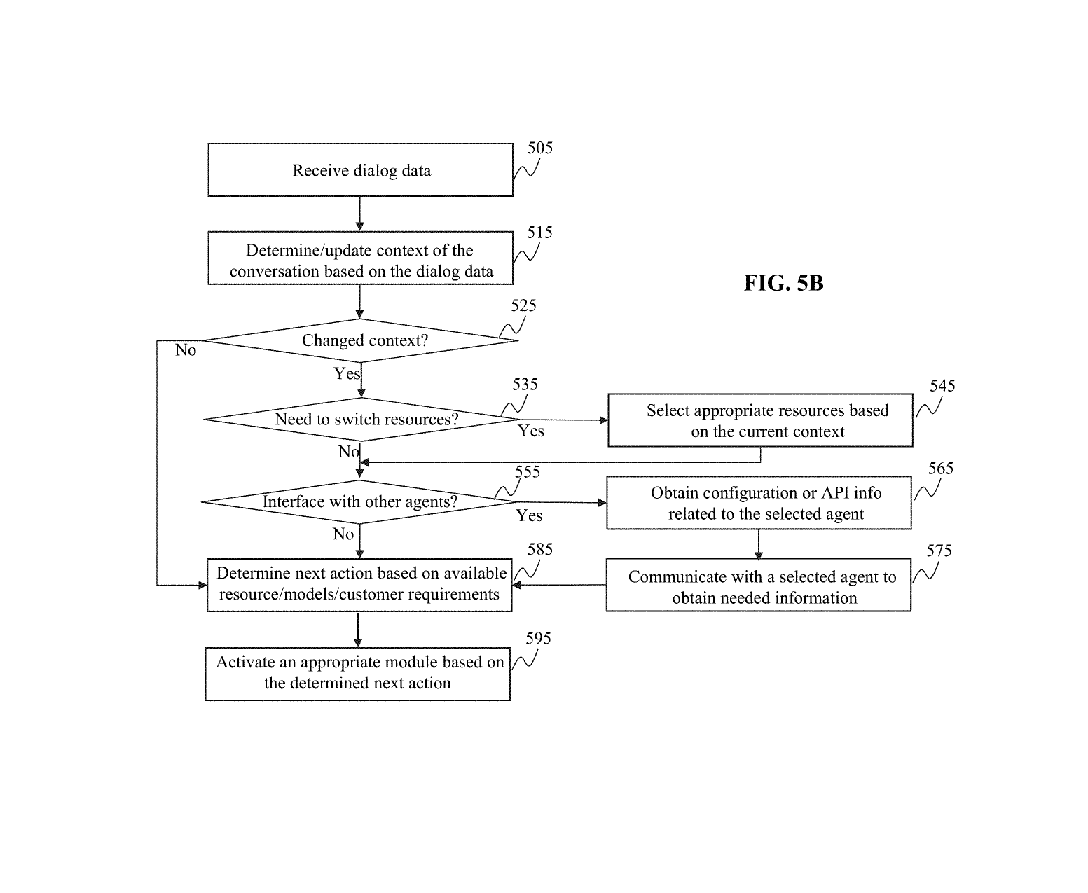

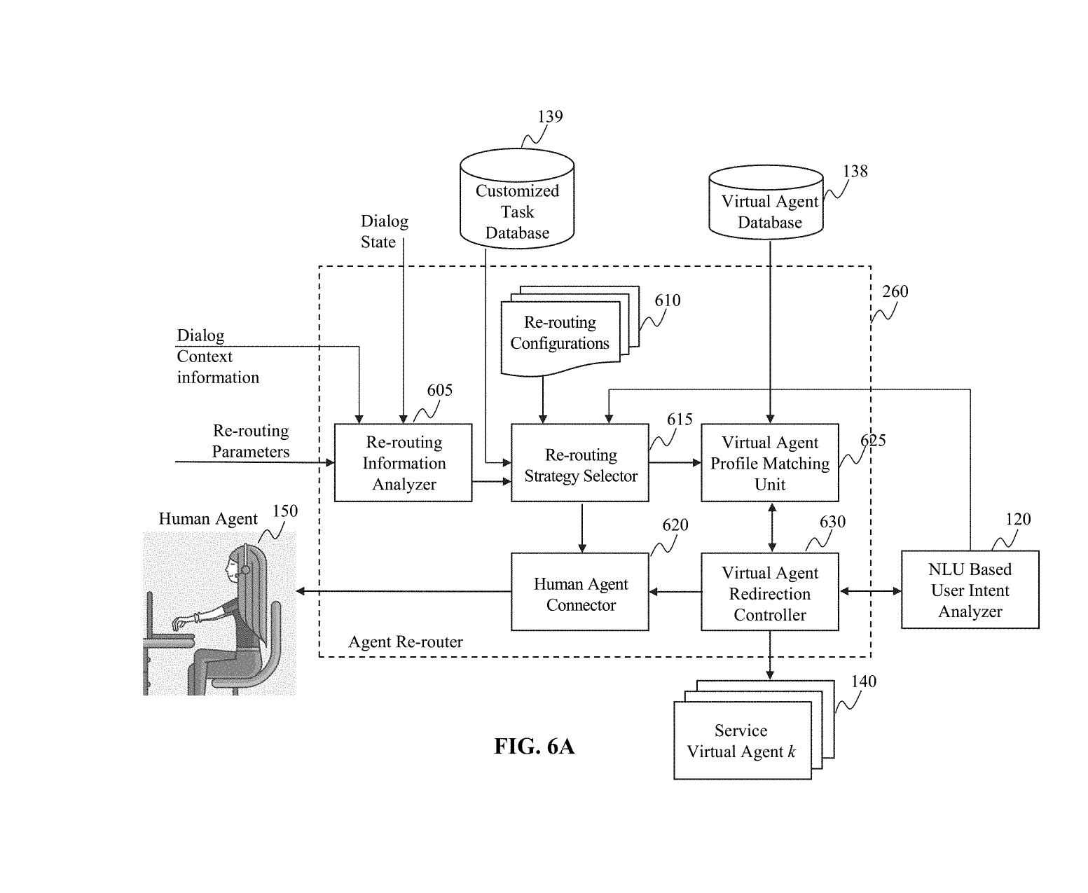

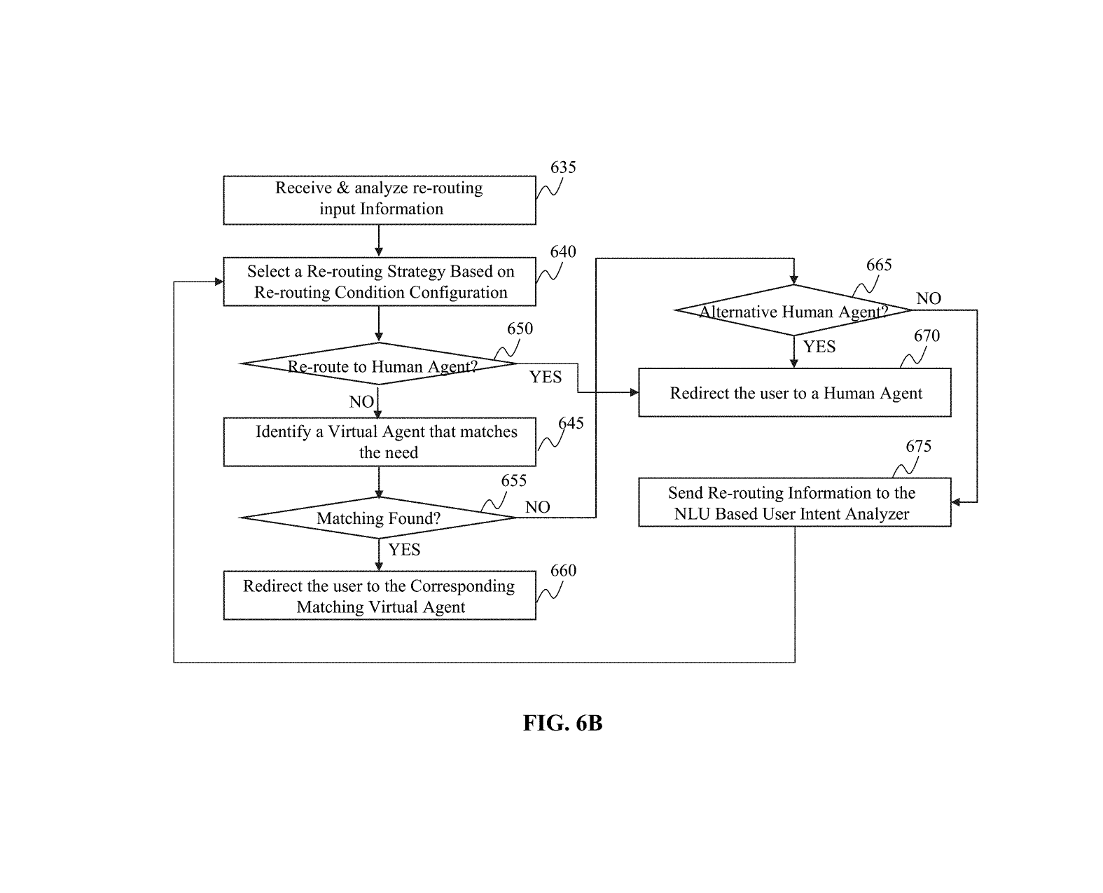

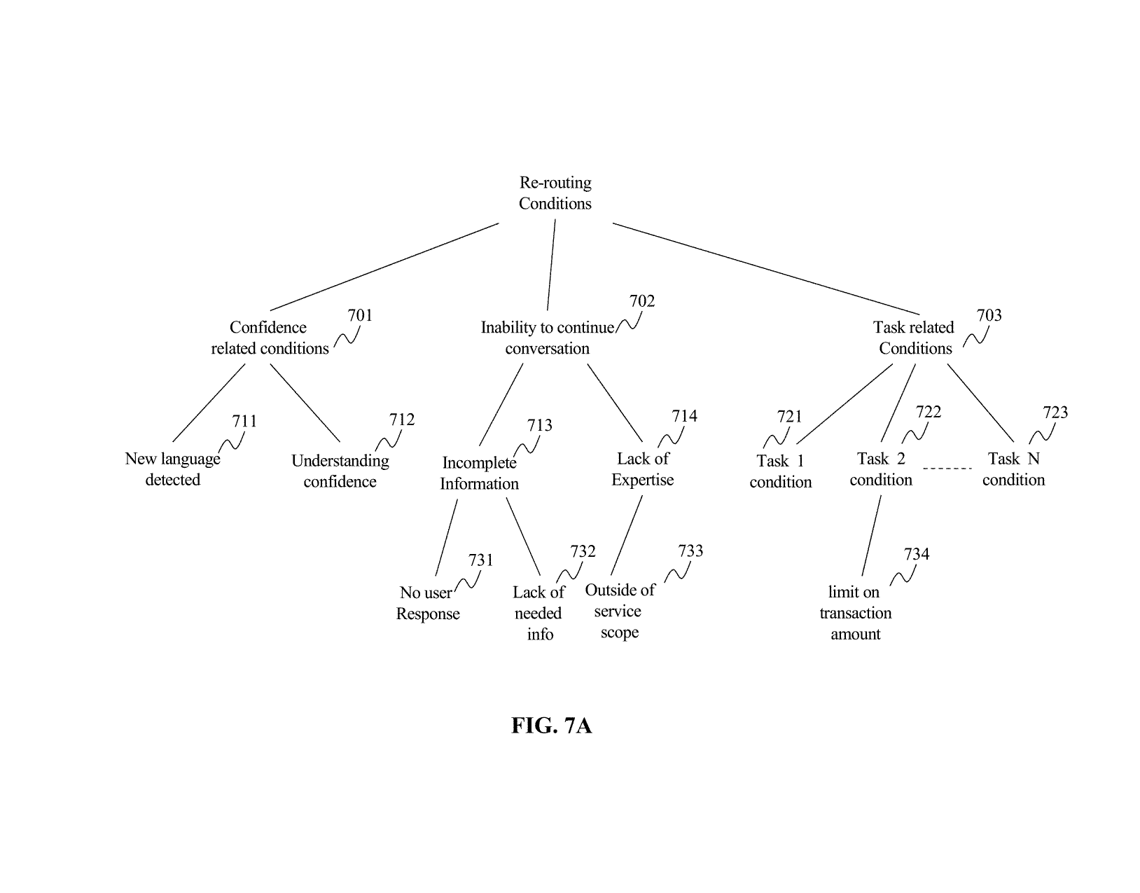

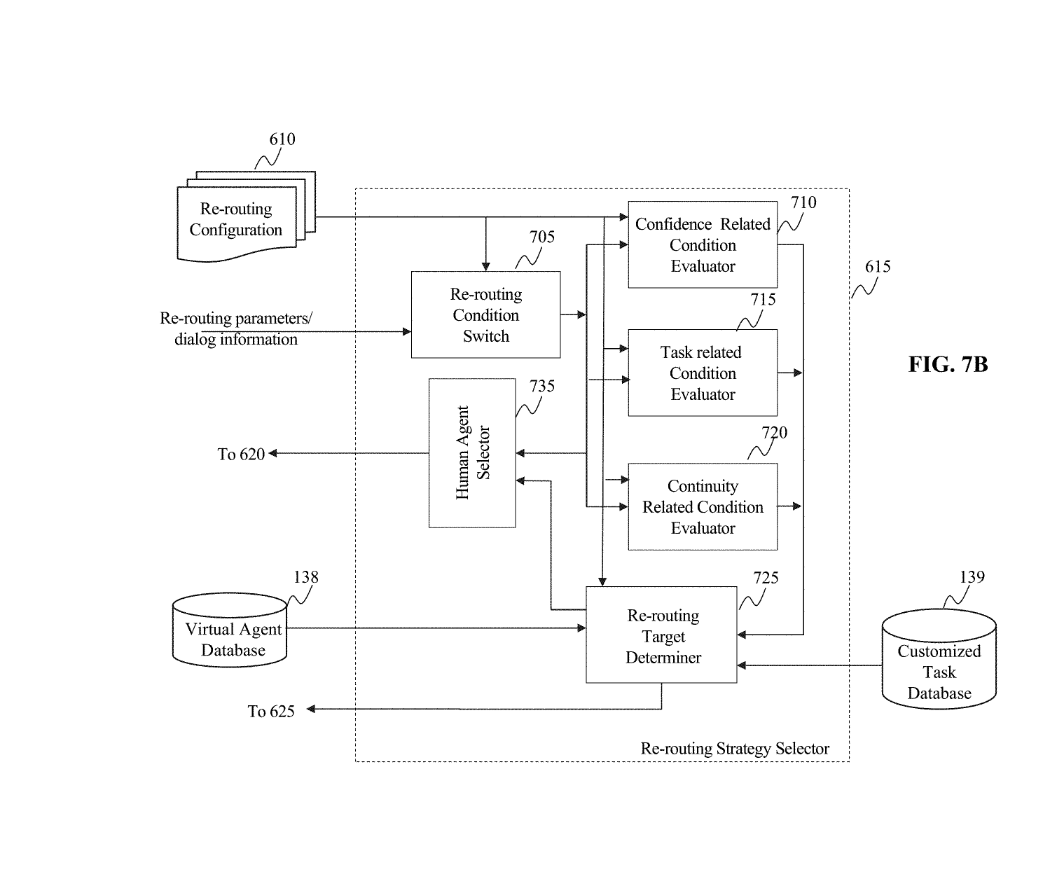

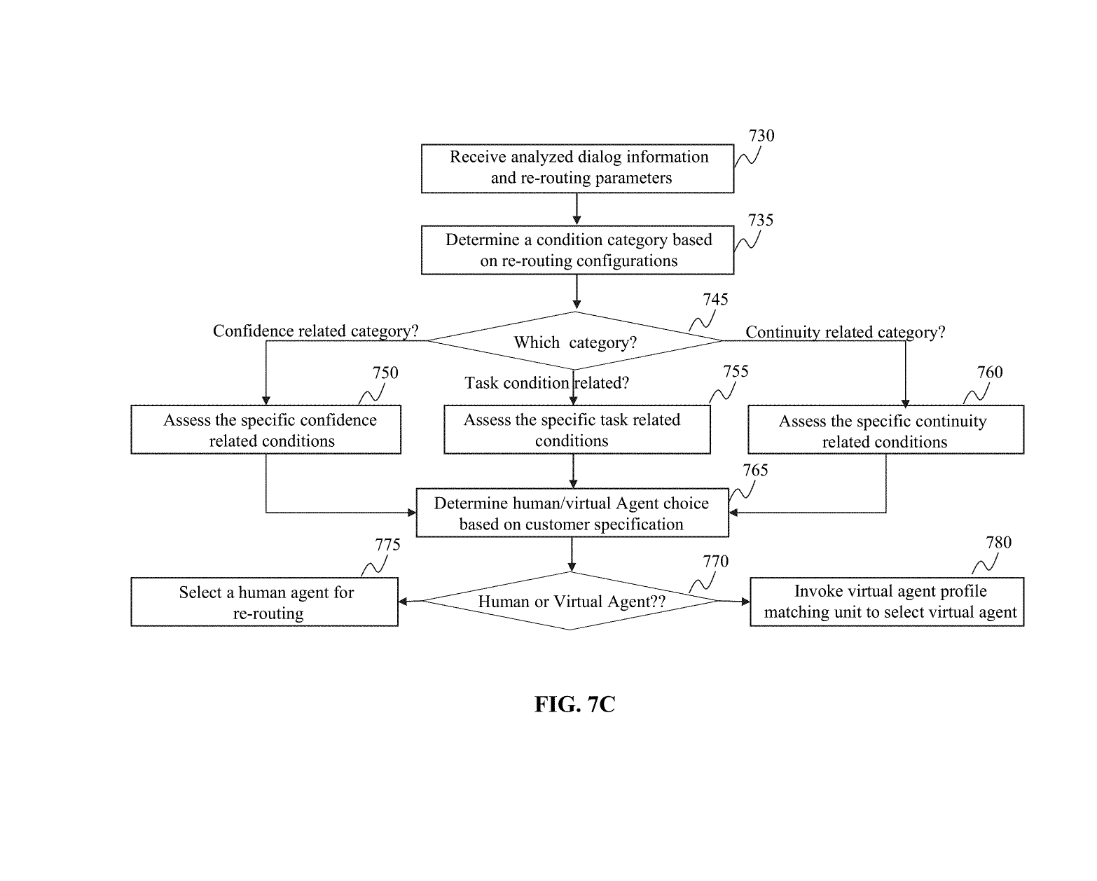

FIG. 5A depicts an exemplary high level system diagram of the real-time task manager 230, according to an embodiment of the present teaching. In this illustrated embodiment, the real-time task manager 230 comprises a current task context updater 510, a task context based resource selector 530, a context-based action manager 540, and an inter-agent communication handler 560. In operation, the real-time task manager 510 receives the dialog related data from the dynamic dialog state analyzer 210 (see FIG. 2). Among other things, the current task context updater 510 may determine the current context of the present dialog. Once determined, the current task context updater 510 updates the archived task context 520 based on the determined current context. The current context of a dialog may be crucial in determining next action to be taken in the dialog session. This is especially so when the context changes in a dialog session. For example, a dialog may initially be directed to “booking a flight” and the normal context of the dialog may be related to the aspects associated with booking a flight, e.g., origin, destination, dates, etc. However, a user may start to inquire about hotel reservation at the destination so that there is a context change. In some situation, such a context change may mean that the task is also changed so that the current dialog needs to be terminated and a new dialog with a new agent has to be initiated. This situation is handled by agent re-routing, which is to be discussed with reference to FIGS. 6A-7C.

Upon the updated context, the context-based action manager 230 may, based on the received dialog data (which may be forwarded by the current task context updater 510 or directly received (not shown)), determine the next action to be performed based on the deep learning models 225 and/or the information related to the specific customers on the specific tasks stored in 139. In such a determination, the current context may also be considered. The next action may be to (1) respond to an inquiry from the user by invoking machine utterance generator 240 based on information gathered based on the current context, (2) recommend a product/service to the user if all the information gathered so far is adequate to proceed to that (determined based on, e.g., the deep learning models 225), or (3) re-route the user to a different agent, whether human or a different service virtual agent if it is determined that what the user asks for cannot be accomplished by the current service virtual agent (determined based on, e.g., the deep learning models 225).

If the context does not change, the context-based action manager 540 may proceed with its operation based on resources previously made available to it. If there is a change in context, the context-based action manager 540 may need to invoke some preprocessing to ensure that appropriate resources are selected to accommodate the changed context. In some situations, the context change may be related to the initial service so that the current service virtual agent may be able to accommodate the user's request. According to the present teaching, this may be achieved by switching the resources in a context sensitive manner so that the current service virtual agent may utilize such context sensitive resources to handle the changing context. Resources that may be switched in a context sensitive manner include databases to be used to search for relevant information, other virtual agents that the current service virtual agent can communicate with to gather requested information, and/or necessary communication configurations or APIs required for the current service virtual agent to communicate with a selected virtual agent.

For example, when a user in a dialog session for “booking a flight” switches the topic about hotel availability at the destination, this is a context change. When this happens, the context-based action manager 540, upon being informed of a context change (e.g., by the current task context updater 510), the context-based action manager 540 may activate the task context based resource selector 530 to select resources suitable for the current context (stored in 520).

Upon being invoked, the task context based resource selector 530 may determine appropriate resources needed for the updated context and make them available to the context-based action manager 540. Switchable resources may include databases 130 and virtual service agents 140. For example, during the dialog with the user for “booking a flight,” the user may ask the question on the weight/size limits of luggage for a flight reserved from a particular airline. In this case, the task context based resource selector 530 may select a specific database in 130 from which such information on weight/size limitation can be found by the context-based action manager 540 in order to respond to the user's inquiry.

Taking the previous example of context switch to “hotel reservation,” the task context based resource selector 530 may select a virtual agent for “booking hotel” as a resource that the current virtual agent on “booking a flight” can communicate with to get the needed information for the user. When selecting an appropriate virtual agent from 140 to assist the current service virtual agent to handle a changing context, the task context based resource selector 530 may also retrieve configuration information or APIs associated with the selected virtual agent necessary for communication.

To accommodate a dynamically changed context may require communicating with another virtual agent, which is selected by the task context based resource selector 530. In this situation, the current service virtual agent may communicate with the selected virtual agent to gather information needed to continue the dialog with the user. The communication may be achieved by invoking the inter-agent communication handler 560. The task context based resource selector 530 may, when selecting other virtual agent(s), retrieve API related information and store it in an inter-agent communication configurations file 550 to enable the inter-agent communication handler 560 to proceed with the communication.

While invoking the inter-agent communication handler 560, the context-based action manager 540 may provide information from the current dialog to the inter-agent communication handler 560 to appropriately conduct the inter-agent communication. For example, taking the example on a changed context from “booking a flight” to “booking a hotel,” information about the destination revealed in the dialog related to “booking a flight” needs to be provided to the selected agent for “booking a hotel” if the user's request is to book a hotel at the destination of the flight.

With information needed to communicate with a selected virtual agent, the inter-agent communication handler 560 may then interface with the selected agent to gather needed information. Such gathered information may then be transmitted to the context-based action manager 540, which may then proceed to answer the user's inquiry about hotel availability at the destination, if the next action is determined to be continuing with the dialog.

During a dialog, it is possible that the context changes multiple times. For example, a user in a dialog session for “booking a flight” may take a detour to ask questions related to hotel availability at the destination on/after the date of the reserved flight, may continue to ask the weight/size limit of the booked flight, or even ask the weather at the destination on or after the date of arrival. The real-time task manager 230 may then proceed to handle such continuing changing context according to the present teaching as disclosed herein.

FIG. 5B is a flowchart of an exemplary process of the real-time task manager 230, according to an embodiment of the present teaching. When the current task context updater 510 receives, at 505, data of the current dialog, it determines, at 515, the current context of the dialog from the dialog data and updates the task's current context in 520. Based on whether the context is changed, determined at 525, it is decided, at 535, whether the resources need to be switched or re-selected. If the resource switch is needed, the task context based resource selector 530 is invoked to select, at 545, resources appropriate for the current context. It is further determined, at 555, whether it is needed to interface or communicate with a different selected agent (whether human or not). If a communication with a different agent is needed, the inter-agent communication handler 560 retrieves, at 565, configuration or API information associated with the selected agent and then communicates, at 575, with the selected agent to obtain needed information.

With information needed available, the context-based action manager 540 determines, at 585, the next action to take for the dialog session based on available resources, the deep learning models 225, and optionally customer requirements. Based on the determined next action, the context-based action manager 540 activates, at 595, appropriate modules in the system, including the machine utterance generator 240 (if the next action is to continue the dialog with the user), the recommendation engine 250 (if the next action is to recommend a product/service), and the agent re-router 260 (if the next action is to re-route to a different agent).

FIG. 6A depicts an exemplary high level system diagram of the agent re-router 260 in a service virtual agent, e.g. the service virtual agent 1 142 in FIG. 2, according to an embodiment of the present teaching. In this exemplary embodiment, the agent re-router 260 comprises a re-routing information analyzer 605, a re-routing strategy selector 615, a virtual agent profile matching unit 625, a virtual agent redirection controller 630, a human agent connector 620, and one or more re-routing condition configurations 610. In this illustrated embodiment, the re-routing information analyzer 605 receives different information from different sources as input, including re-routing parameters with dialog context information from the real-time task manager 230 and optionally the dialog state.

As discussed herein, the need for re-routing may arise under different circumstances. Depending on the reasons for the re-routing, the re-routing strategy may vary. Upon receiving different types of input information, the re-routing information analyzer 605 analyzes the received information to ascertain, e.g., the reason(s) for re-routing. For example, the re-routing parameters may indicate such reasons, including, e.g., that the user has a satisfaction score lower than a threshold, the user wants to start a transaction involving a price higher than a pre-set threshold, the user's newly estimated intent is not associated with the domain of the current virtual agent, or the user has expressed an intent to speak with a human agent, e.g. a human representative. The re-routing information analyzer 602 may then send information indicating the underlying reason for the re-routing and optionally with the re-routing parameters to the re-routing strategy selector 615 for selecting an appropriate re-routing strategy.

Based on the re-routing parameters, the re-routing strategy selector 615 may select one of the re-routing strategies, determined based on the re-routing configurations in 610 for selecting a re-routing strategy for the user. A re-routing configuration may indicate how to re-routing the user and/or the user should be re-routed based on what condition with what threshold. For example, a selected re-routing may indicate that when the user's newly estimated intent is not associated with the domain of the current virtual agent, the agent re-router 260 is to find another virtual/human agent that has a domain matching the user's newly estimated intent. In another example, the re-routing configuration 610 may indicate various conditions under which the dialog needs to be switched to a different agent, whether virtual or human depending on the availability or the preference of the specific customer. For instance, when the confidence score of the dialog is lower than a threshold (due to, e.g., difficulty in understanding user's input or user's responses somehow do not provide needed information to continue the dialog, etc.), the dialog may need to be switched to a human agent. When the user wants to start a transaction involving a price higher than a threshold, a human agent may need to be involved to be cautious. When the user has expressed his/her desire to speak with a human agent, the agent re-router 260 is also to escalate the user to a human agent regardless of the newly estimated user intent. When the detected user's intent indicates that the current service virtual agent is not equipped to handle, the agent-re-router 260 is to route the user to a different service virtual agent that has the expertise to handle the user's desired task.

In some embodiments, the re-routing strategy may be selected based also on the preference of an owner of the virtual agent. An owner of a virtual agent may correspond to a party that develops the virtual agent and deploys it in a business setting. For example, expedia.com may deploy some virtual agents for “booking flight” or travel.com may employ virtual agents for “booking hotels.” In this example, expedia.com and travel.com are owners of such deployed virtual agents. Deploying virtual agents may save such owners costs of operating the business. However, to maintain service quality, human agents are still put in place in the event that virtual agents need human agent to assist to resolve different situations. So, there is a balance between using virtual agents and human agents to achieve business objectives. Different owners may have different preferences as to how they like to reach such a balance. Such preferences may be stored in the customized task databases 139 and may be considered by the re-routing strategy selector 615 in determining the re-routing strategy. This is shown in FIG. 6A. Details related to the re-routing strategy selector 615 are provided with reference to FIGS. 7A-7B.

According to the selected re-routing strategy, the re-routing strategy selector 615 may invoke either the virtual agent profile matching unit 625 to find a virtual agent having a profile matching the user's newly estimated intent or desired task, or the human agent connector 620 to connect the user to the human agent 150. In accordance with one embodiment of the present teaching, the re-routing configuration 610 may also be provided to dictate that it is preferred to re-route the user to a virtual agent (to save cost) rather than directly to a human agent. In this case, the re-routing strategy selector 615 may invoke first the virtual agent profile matching unit 625 for identifying a virtual agent that can handle the situation, and only when the virtual agent profile matching unit 625 cannot find a virtual agent having a profile matching the user's newly estimated intent, the re-routing strategy selector 615 may then invoke the human agent connector 620 to connect the user to the human agent 150.

The virtual agent profile matching unit 625 in this example may obtain profiles of different virtual agents from the virtual agent database 138. It can be understood that the virtual agent database 138 may store additional information rather than merely the profiles of the virtual agents. For example, the virtual agent database 138 may also provide contextual information, metadata related to each virtual agent, and/or APIs needed to electronically connect with each virtual agent. A profile of a virtual agent may indicate what domain or service the virtual agent is associated with. Based on the agent profiles and the requested domain expertise of a needed virtual, the virtual agent profile matching unit 625 may determine a matching score between each virtual agent's profile and the requested domain expertise needed for the estimated user intent or desire. Then the virtual agent profile matching unit 625 may determine whether a matching virtual is found and if so, may select a virtual agent having certain matching score, e.g., the highest matching score, as the matching virtual agent. Information related to the selected virtual agent, optionally together with the matching score, may then be sent to the virtual agent redirection controller 630 for redirection control.

The virtual agent redirection controller 630 in this example may receive information about the selected matching virtual agent from the virtual agent profile matching unit 625, and redirect the user based on the determined re-routing strategy. In one example, the re-routing strategy may dictate that the virtual agent redirection controller 630 may directly re-route the user to the selected virtual agent, e.g. service virtual agent k, regardless how high or how low the matching score is. In another example, the selected re-routing strategy may dictate that the virtual agent redirection controller 630 may first compare the matching score of the selected virtual agent with a threshold, and re-route the user to the selected virtual agent when its matching score is higher than the threshold. In the event that the matching score of the selected virtual agent is lower than the threshold, the virtual agent redirection controller 630 may either invoke the human agent connector 620 to connect the user to the human agent 150, or invoke the NLU based user intent analyzer 120 for a determination of, e.g., whether there exist a secondary user's intent so that an alternative virtual agent may be further selected for re-direction via the virtual agent profile matching unit 625.

FIG. 6B is a flowchart of an exemplary process of the agent re-router 260 in a service virtual agent, according to an embodiment of the present teaching. Inputs for re-routing, e.g., re-routing parameters, etc., are received and analyzed at 635. Based on the received re-routing parameters, a re-routing strategy is selected, at 640, based on the re-routing configurations. A matching virtual agent is determined, at 706, based on the re-routing strategy. The matching virtual agent may be selected based on a matching score computed based on the profile of a virtual agent and the estimated user's intent.

The re-routing strategy may indicate whether the user needs to be re-routed to a virtual agent or a human agent. If the re-routing strategy indicates that the user needs to be redirected to a human agent, determined at 650, the human agent connector 620 is invoked to redirect the user, at 670, to a human agent. If the re-routing strategy indicates that the user needs to be redirected to a virtual agent, the virtual agent profile matching unit 625 is invoked to identify, at 645, a virtual agent that match what the user needs according to the re-routing strategy. The matching result may be sent to the virtual agent redirection controller 630.

If a matching virtual agent is found, determined at 655 by the virtual agent redirection controller 630, the user is redirected to the selected matching virtual agent in 140. If a matching virtual agent is not found, the virtual agent redirection controller 630 determines, at 665, whether alternatively a human agent can be invoked in place of the desired virtual agent. If an alternative human agent is needed, the virtual agent redirection controller 630 invokes the human agent connector 620 so that the user may be connected to a human agent instead.

If an alternative human agent is not desired in the event a matching virtual agent is not found, the agent re-router 260 optionally may send, at 675, needed information to the NLU based user intent analyzer 120 in order to further identify alternative or additional intent of the user. Such further intent, once identified, may then be sent to the re-routing strategy selector 615 (see FIG. 6A) to select an alternative re-routing strategy at 640.

FIG. 7A illustrates exemplary types of re-routing conditions, according to an embodiment of the present teaching. As discussed herein, re-routing configurations may specify different conditions under which a user needs to be re-routed as well as corresponding indication as to where (human or virtual) and which agent the user is to be re-routed. In FIG. 7A, various exemplary re-routing conditions are illustrated. For example, re-routing conditions may be triggered by low confidence in the dialog (701), inability of continue the dialog (702), and certain natures of the tasks involved (703). With respect to the category of low confidence in the dialog, the conditions giving rise to re-routing may include the detection of a new language unknown to the current virtual agent (711), . . . , or low confidence in the level of understanding of what the user said (712).

With respect to the category of inability of continue the dialog, specific conditions giving rise to the re-routing include, e.g., incomplete information (713), . . . , or lack of expertise (714). The reason of incomplete information may be due to failure to receive a response from the user (731), . . . , or inability to obtain needed information from the user (732). As to the category of lack of expertise, it may include the situation in which the user asks for something that is outside the scope of service of the current virtual agent (733). With respect to the category that define various task conditions under which special agents need to be involved so that the user is to be re-routed to the pre-defined special agents. In FIG. 7A, under this category, there may be different tasks (721, 722, . . . , 723) that may require special agents under certain conditions. One example is task 722 which may be defined as involving a transaction, the condition for a re-routing may be when the amount of money involved in the transaction exceeds a certain limit (734). In this situation, a human agent may be required to get involved so that the user may need to be re-routed to a human agent.

FIG. 7B depicts an exemplary high level system diagram of the re-routing strategy selector 615, according to an embodiment of the present teaching. In this exemplary embodiment, the re-routing strategy selector 615 comprises a re-routing condition switch 705, a confidence condition evaluator 710, a task related condition evaluator 715, a continuity related condition evaluator 720, a re-routing target determiner 725, a virtual agent selector 730, and a human agent selector 735. The re-routing strategy selector 615 may determine not only the strategy of whether to re-route to a human or a virtual agent but also which agent, whether human or virtual, the user is to be re-routed to. Such determinations may be made based on various considerations, including, e.g., the condition under which the need of re-routing arises, the preference of the customer (e.g., prefer to use as much virtual agent as possible to save cost), the scope of expertise of different agents, availability of agents (especially human agents), etc.

In operation, the re-routing condition switch 705 receives input, which may include re-routing parameters and analysis result of the dialog information, etc., and invokes different modules 710-720 to evaluate the conditions of appropriate categories. The switch is performed based on the re-routing configuration 610. Depending on the re-routing parameters, the confidence condition evaluator 710 may be invoked by the re-routing condition switch 705 to assess the conditions related to the confidence in the dialog. The task related condition evaluator 715 may be invoked when the condition giving rise to the re-routing operation is related to specific tasks. Similarly, the continuity related condition evaluator 720 may be invoked if the re-routing parameters indicate that the re-routing is due to issues related to inability to continue the dialog.

Each of the modules 710, 715, and 720 may assess how the current dialog situation meet which conditions of that category and then accordingly report the assessment to the re-routing target determiner 725, which may determine whether a human or virtual agent is to be used to continue the dialog. To do so, the re-routing target determiner 725 may rely on the information from the customized task database 139 and/or the information from the virtual agent database 138. The customized task database 139 may store information related to preference of the customer with respect to different tasks on whether and when a human agent is to be used. Some customers may prefer to use human agent when in doubt in order to provide high quality service to the user. Some customers may prefer to utilize virtual agents as much as possible to save cost. Such information may be relied on by the re-routing target determiner 725 to determine the target agent to whom the user is to re-routed.

The re-routing target determiner 725 may also rely on information from the virtual agent database 138, which may specify classes of virtual agents for different types of tasks. Depending on the task in hand, the re-routing target determiner 725 may determine a class of targets to be used to continue to serve the user. For example, if the task in hand is for booking a flight, although there are many different class of virtual agents specified in the virtual agent database 138, the re-routing target determiner 725 may narrow down the selection scope to be limited to the class of virtual agents that are for booking a flight with different scopes of services.

When the re-routing target is a human agent, the human agent selector 735 is invoked to select a human agent. Such a selection may be based on an archive enlisting all the human agents (not shown). In some embodiments, the selection of a human agent may be made based on different factors. For example, expertise possessed by the human agents may be crucial in making a selection. In some situations, location of the human agent may also matter. Other considerations may also come into play. Once selected, the human agent selector 735 sends information related to the selected human agent to the human agent connector 620 so that the connection between the user and the selected human agent may be established.

When the re-routing target is a virtual agent, the determination is sent to the virtual agent profile matching unit 625, where a specific virtual agent in the determined category may be selected. As discussed herein in reference to FIG. 6A, such a selection may be made based on information in the virtual agent database 138. For each virtual agent, different descriptions stored in 138 for each virtual agent may be accessed to facilitate the selection. In some embodiments, the scope of expertise or services for each agent may be used to evaluate whether it is a reasonable choice. For example, there may be multiple virtual agents for task “booking a flight.” Some of those virtual agents may be limited to handle only issues related to flights so that if any other inquiry such as hotel availability will cause a re-routing to a different agent, while others may be capable of handle all detour issues by itself. The virtual agent profile matching unit 625 may select a virtual agent based on the context of the current dialog.

FIG. 7C is a flowchart of an exemplary process of the re-routing strategy selector 615, according to an embodiment of the present teaching. Analyzed dialog information and the re-routing parameters are received at 730. Based on the received information, a category of conditions giving rise to the need for re-routing is determined, at 735, based on the re-routing configurations 610. According to the determined category of conditions, the re-routing condition switch 705 determines, at 745, which appropriate module to invoke in order to evaluate in detail the specific conditions in order to properly determine the re-routing strategy. The confidence related condition evaluator 710, once invoked, assesses, at 750, the specific conditions in the confidence category associated with the current dialog session. The task related condition evaluator 715, once invoked, assesses, at 755, the specific conditions in the category of tasks related conditions associated with the current dialog session. The continuity related condition evaluator 720, once invoked, assesses, at 760, the specific conditions in the category of continuity related conditions associated with the current dialog session.

The assessed specific conditions obtained from any of the condition evaluators 710, 715, and 720, when received by the re-routing target determiner 725, a determination is made, at 765, whether a human or virtual agent is to be selected for the re-routing. If the re-routing target is a human agent, determined at 765, the human agent selector 735 is invoked to select, at 775, an appropriate human agent for the re-routing. If the re-routing target is a virtual agent, the virtual agent profile matching unit 625 is invoked to determine a virtual agent via, e.g., profile matching.

FIG. 8 illustrates an exemplary user interface 800 during a dialog between a service agent and a chat user, according to an embodiment of the present teaching. As shown in FIG. 8, the service agent called “Gingerhome” is chatting with a chat user called “VISITOR 14606593.” Shown in FIG. 8 is an exemplary bot-assisted agent-side conversation user interface. That is, it is an interface used by a human agent who is assisted by a virtual agent. The interface include different dialog boxes in which each side (chat user and the bot-assisted agent) can each enter their sentences (820, 830, and 840). This agent-side interface also includes various types of information and different actionable sub-interfaces. For example, it includes some historical information related to the current ongoing conversation, shown to list “previous tickets/talks” (850). It also provides agent-selectable actions (860) which may be presented, once clicked, as a drop-down list, editable tags (870). The bot-assisted agent may also add topic tags about the current chat. The agent is assisted by a bot. For example, when the chat user asked “What is your return policy?” (in 840), the bot that is assisting the human agent provides a list of possible responses corresponding to a list of possible utterances tagged as “Assisted by Rulai.” Each of the list of utterances suggested by the bot may be adopted by the human agent when the associated “Send” icon is clicked. In this example, a list of alternative choices of utterances is provided in response to the chat user's question “what is your return policy” in 840.

The conversation between a chat user and a bot-assisted human agent may continue as in a FAQ dialog or additional task oriented virtual agent may be triggered to take over the conversation with the chat user. For example, the conversation in boxes 820, 830, and 840 may correspond to an FAQ. In certain situations, in order to carry on a conversation, some task oriented agent, whether a human or a virtual agent, may be triggered. For example, when the chat user asks “What is your return policy,” the bot assisting the human agent provides several possible responses as provided in 880. The bot-assisted human agent may then select one response by clicking on a corresponding “Send” icon, e.g., selecting response “Sure. I can explain to you.” Such a selected response may trigger a virtual agent, e.g., in this case, a virtual agent that specializes in “explaining return policy.” Once selected, the selected task oriented virtual agent (for explaining return policy) may then step in to continue the conversion with the chat user.

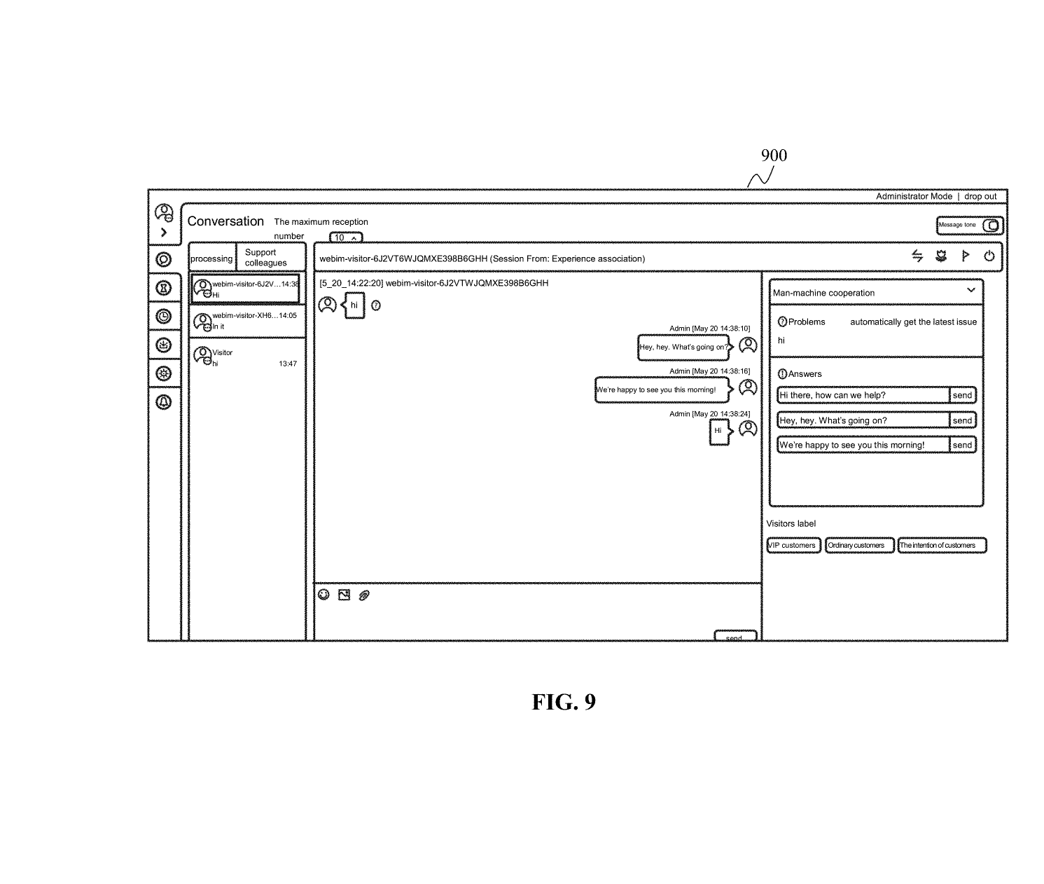

FIG. 9 illustrates an exemplary user interface 900 during dialogs between a service virtual agent and multiple chat users, according to an embodiment of the present teaching. As shown in FIG. 9, the service virtual agent called “Admin” can chat with multiple chat users in a same time period. FIG. 9 shows a specific time instance while the virtual agent is currently chatting with a chat user called “webim-visitor-6J2VTWJQMXE398B6GHH.” In this interface, different bot suggested responses may be presented to the agent. The bot-assisted agent can activate “Send” of a desired response and send the corresponding response utterance to the chat user. Such suggested responses may be used by the agents to carry on a conversation. When assisted by bot suggested responses, the agents according to the present teaching can handle multiple customer requests simultaneously via this interface at ease.

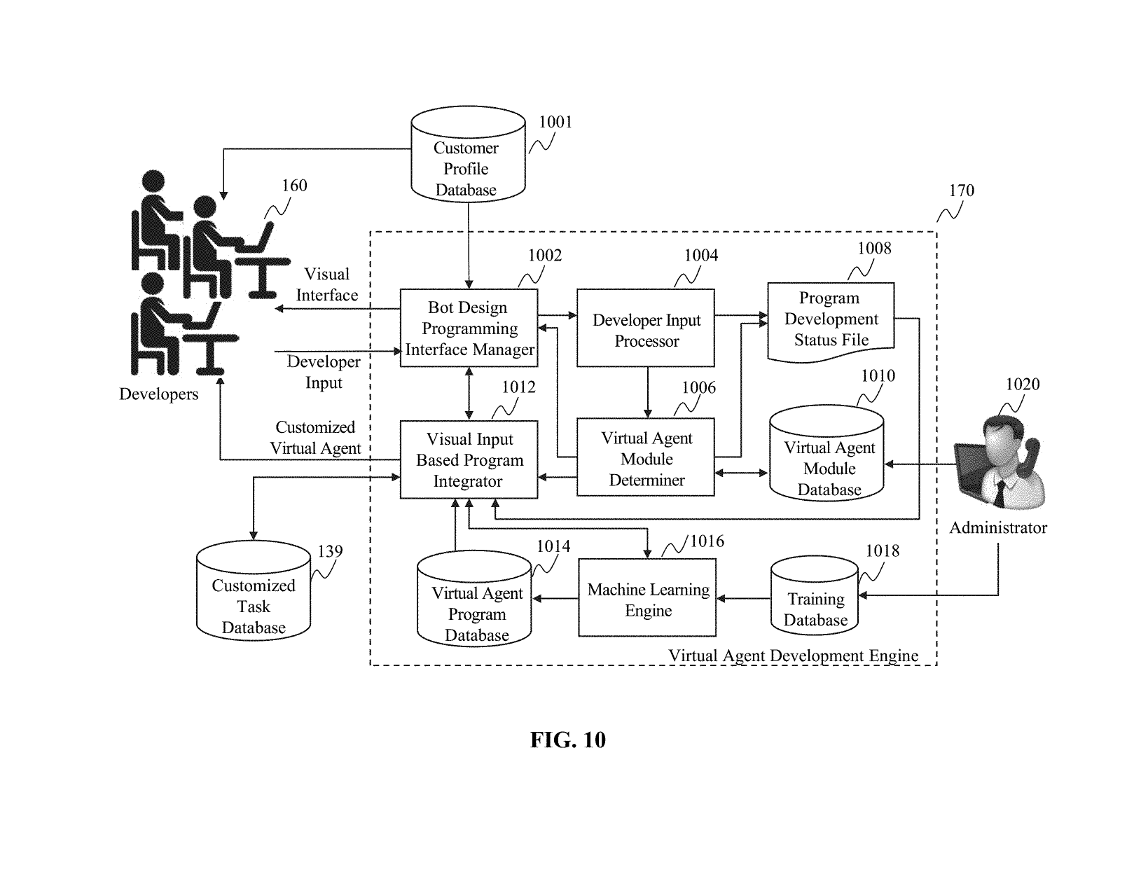

FIG. 10 depicts an exemplary high level system diagram of a virtual agent development engine 170, according to an embodiment of the present teaching. As shown in FIG. 10, the virtual agent development engine 170 in this example includes a bot design programming interface manager 1002, a developer input processor 1004, a virtual agent module determiner 1006, a program development status file 1008, a virtual agent module database 1010, a visual input based program integrator 1012, a virtual agent program database 1014, a machine learning engine 1016, and a training database 1018.

The bot design programming interface manager 1002 in this example may provide a bot design programming interface to a developer 160 and receive inputs from the developer via the bot design programming interface. In one embodiment, the bot design programming interface manager 1002 may present, via the bot design programming interface, a plurality of bot design graphical programming objects to the developer. Each of the plurality of graphical programming objects may represent a module corresponding to an action to be performed by the virtual agent. The bot design programming interface manager 1002 may generate a bot-design programming interface based on different types of information. For example, each customized bot may be task oriented. Depending on the tasks, the bot design programming interface may be different. In FIG. 10, it is shown that information stored in a customer profile database 1001 is provided to the bot design programming interface manager 1002. A customer may be engaged in different types of business, which may dictate what types of tasks that a virtual agent developed for the customer need to be able to handle. In FIG. 10, information from the customer profile database 1001 is provided to the bot-design programming interface manager 1002 and is utilized to make a decision what type of virtual agent is to developed (virtual travel agent, virtual rental agent, etc.).

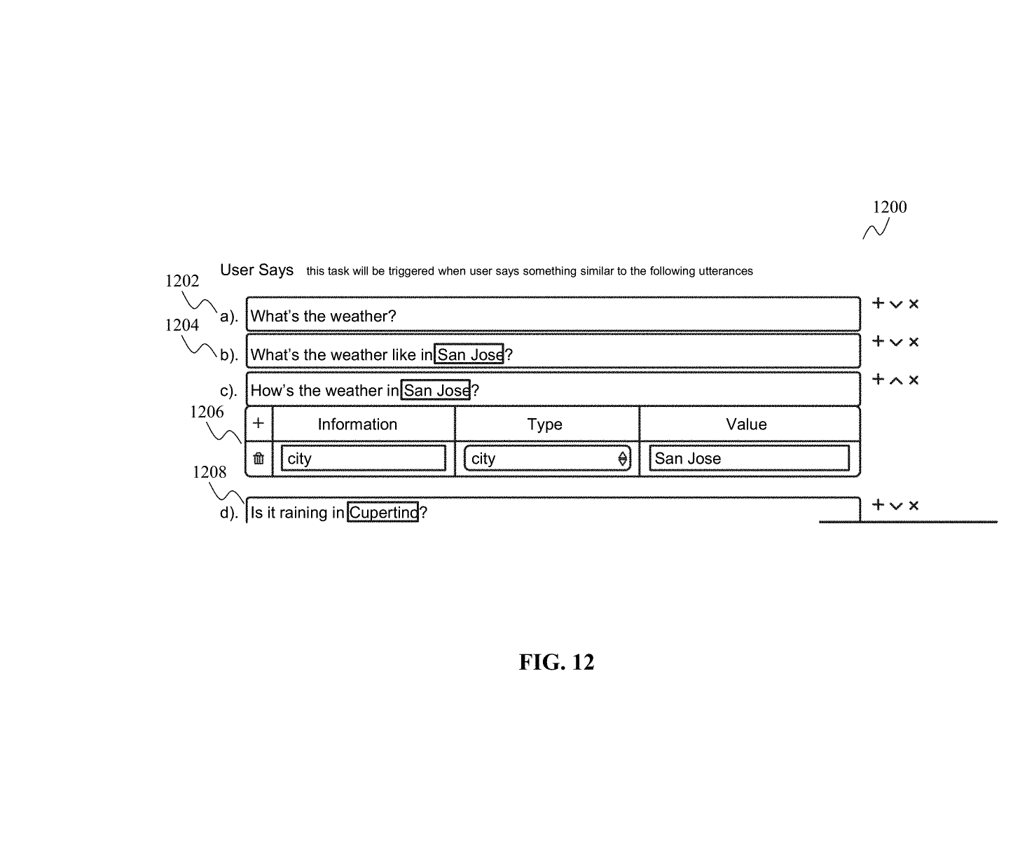

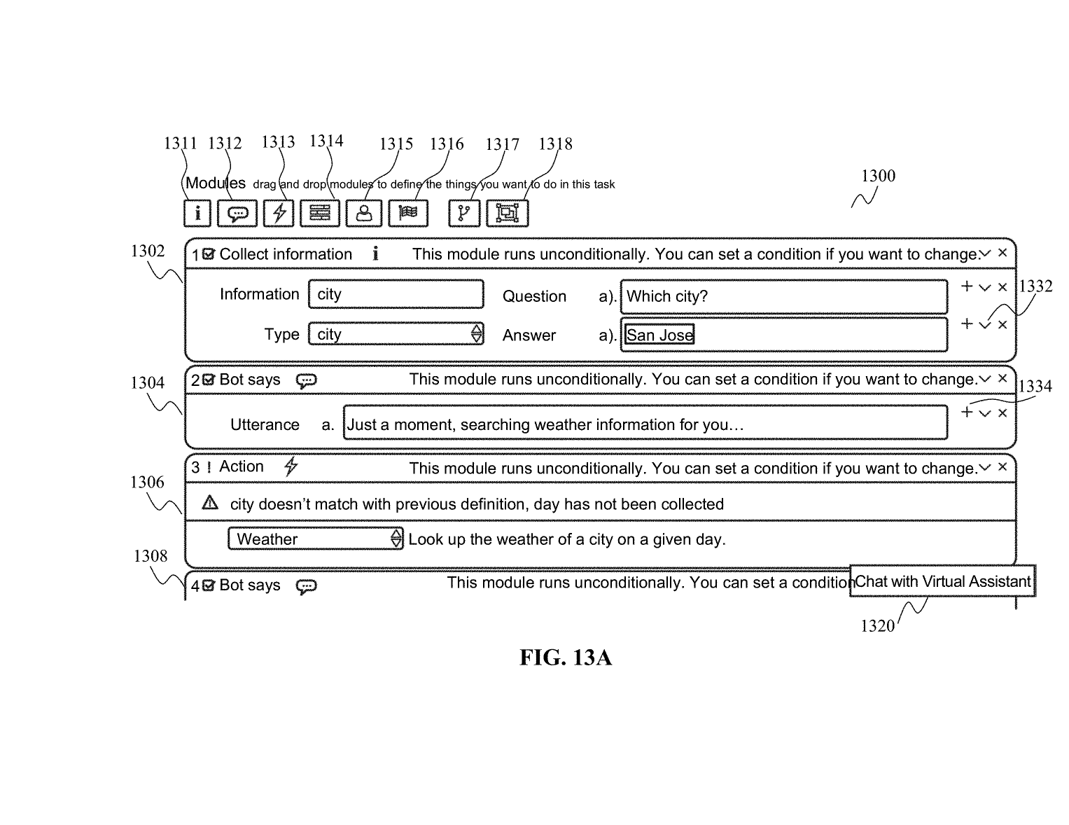

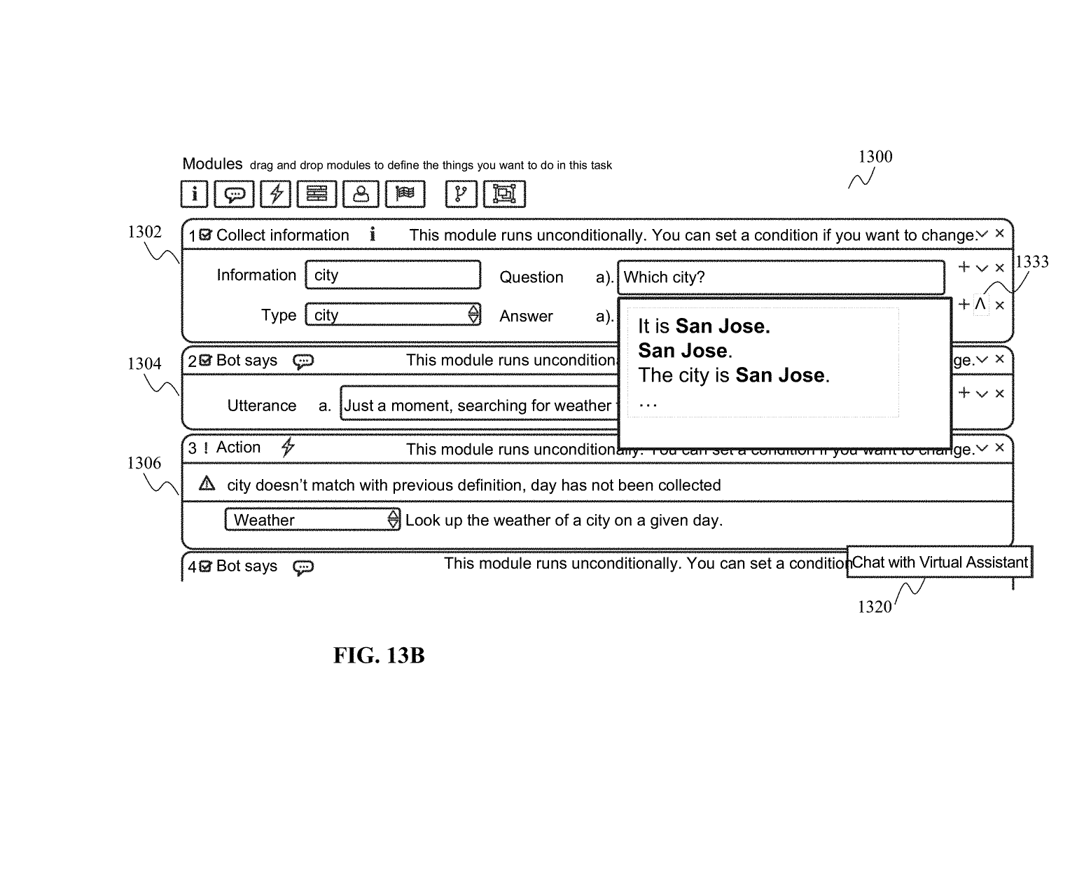

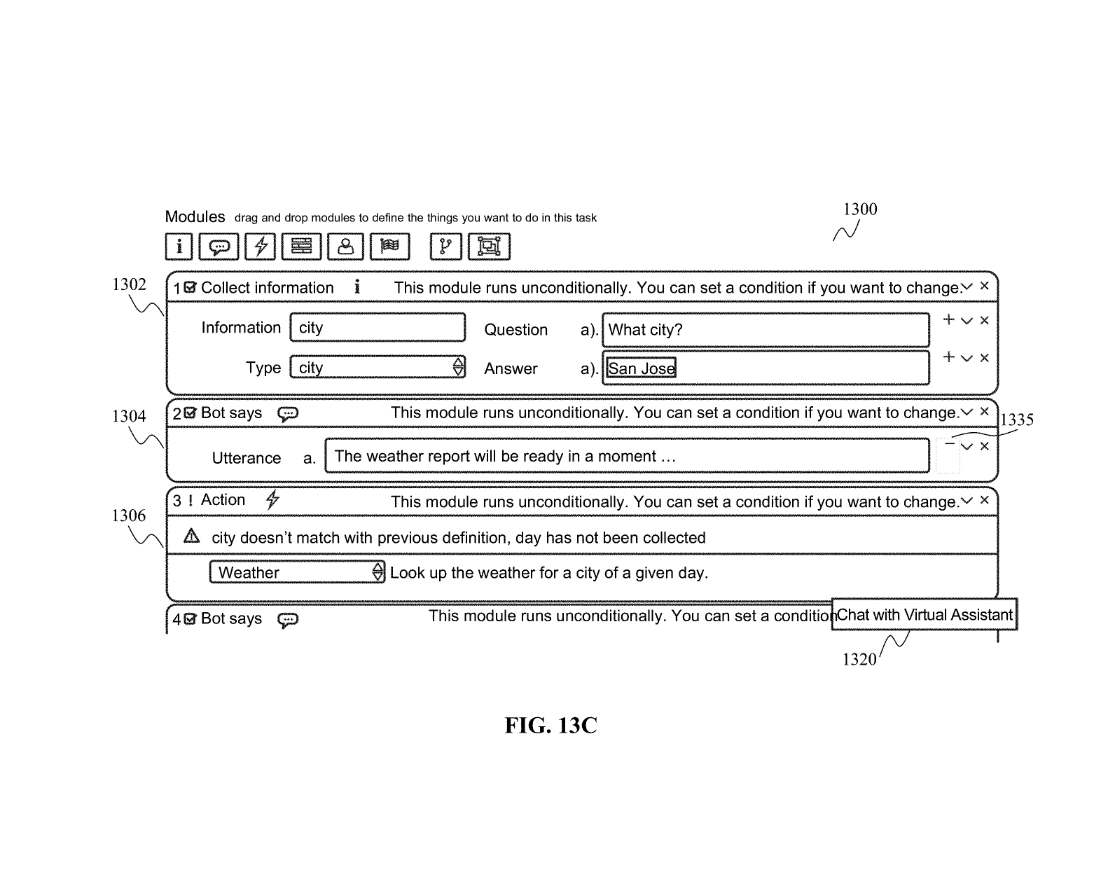

In addition, the past dialogs may also provide useful information for the development of a virtual agent and thus may be input to the bot design programming interface manager 1002 (not shown in FIG. 10). For instance, from archived dialogs, (e.g., gathered from the dialog log databases 212 of different virtual agents), different utterances corresponding to the same task may be identified and offered by the bot design programming interface manager 1002 as alternative ways to trigger the virtual agent in development. This is discussed in more detail in reference to FIGS. 12 and 13B.

The bot design programming interface manager 1002 may forward the developer input to the developer input processor 1004 for processing. The bot design programming interface manager 1002 may also forward the developer input to the visual input based program integrator 1012 for integrating different modules to generate a customized virtual agent with details shown below. It can be understood that the bot design programming interface manager 1002 may cooperate with multiple developers 160 at the same time to developer multiple customized virtual agents.

The developer input processor 1004 may process the developer input to determine the developer's intent and instruction. For example, an input received from the developer may indicate the developer's selection of a graphical object of the plurality of graphical objects, which means that the developer selects a module corresponding to the graphical object. In another example, the input received from the developer may also provide information about the order of the selected module to be included in the virtual agent. The developer input processor 1004 may send each processed input to the virtual agent module determiner 1006 for determining modules of the virtual agent. The developer input processor 1004 may also store each processed input to the program development status file 1008 to record or update the status of the program development for the virtual agent.

Based on the processed input, the virtual agent module determiner 1006 may determine a module for each of the graphical objects selected by the developer. For example, the virtual agent module determiner 1006 may identify the graphical objects selected by the developer. Then for each graphical object selected by the developer, the virtual agent module determiner 1006 may retrieve a virtual agent module corresponding to the graphical object from the virtual agent module database 1010. The virtual agent module determiner 1006 may send the retrieved virtual agent modules corresponding to all of the developer's selection for the virtual agent, to the bot design programming interface manager 1002 for presenting the virtual agent modules to the developer via the bot design programming interface. The virtual agent module determiner 1006 may also store each retrieved virtual agent module the program development status file 1008 to record or update the status of the program development for the virtual agent.

According to one embodiment of the present teaching, the virtual agent module determiner 1006 may determine some of the modules selected by the developer for further customization. For each of the determined modules, the virtual agent module determiner 1006 may determine at least one parameter of the module based on inputs from the developer. For example, for a module corresponding to an action of sending an utterance to the chat user, the virtual agent module determiner 1006 may send the module to the bot design programming interface manager 1002 to present the module to the developer. The developer may then enter a sentence for the module, such that when the module is activated, the virtual agent will send the sentence entered by the developer as an utterance to the chat user. In another example, the parameter for the module may be a condition upon which the action corresponding to the module is performed by the virtual agent, such that the developer may define a customized condition for the action to be performed. In this manner, the virtual agent module determiner 1006 can generate more customized modules, and store them into the virtual agent module database 1010 for future use. The virtual agent module determiner 1006 may send the generated and retrieved modules to the visual input based program integrator 1012 for program integration.

After the developer finishes selecting modules and customizing modules, the developer may input an instruction to integrate the modules to generate the customized virtual agent. For example, the bot design programming interface manager 1002 may present a button on the bot design programming interface to the developer, such that when the developer clicks on the button, the bot design programming interface manager 1002 can receive an instruction from the developer to integrate the modules, and enable the developer to chat with the customized virtual agent after the integrating for testing. Once the bot design programming interface manager 1002 receives the instruction for integrating, the bot design programming interface manager 1002 may inform the visual input based program integrator 1012 to perform the integration.

Upon receiving the instruction for integrating, the visual input based program integrator 1012 in this example may integrate the modules obtained from the virtual agent module determiner 1006. For each of the modules, the visual input based program integrator 1012 may retrieve program source code for the module from the virtual agent program database 1014. For modules that have parameters customized based on inputs of the developer, the visual input based program integrator 1012 may modify the obtained source codes for the module based on the customized parameters. In one embodiment, the visual input based program integrator 1012 may invoke the machine learning engine 1016 to further modify the codes based on machine learning.

The machine learning engine 1016 in this example may extend the source code to include more parameter values similar to exemplary parameter values entered by the developer. For example, for a weather agent having a module collecting information about the city in which weather is queried, the developer may enter several city names as examples. The machine learning engine 1016 may obtain training data from the training database 1018 and modify the codes to adapt to all city names as in the examples. In one embodiment, an administrator 1020 of the virtual agent development engine 170 can input some initial data in the training database 1018 and the virtual agent module database 1010, e.g. based on previous real user-agent conversations and commonly used virtual agent modules, respectively. The machine learning engine 1016 may send the machine learned codes to the visual input based program integrator 1012 for integration.

Upon receiving the modified codes from the machine learning engine 1016, the visual input based program integrator 1012 may integrate the modified codes to generate the customized virtual agent. In one embodiment, the visual input based program integrator 1012 may also obtain information from the program development status file 1008 to refine the codes based on the development status recorded for the virtual agent. After generating the customized virtual agent, the visual input based program integrator 1012 may send the customized virtual agent to the developer. In addition, the visual input based program integrator 1012 may store the customized virtual agent and/or customized task information related to the virtual agent into the customized task database 139.

According to one embodiment of the present teaching, the visual input based program integrator 1012 may store the customized virtual agent as a template, and retrieve the template from the customized task database 139 when a developer is developing a different but similar virtual agent. In this case, the bot design programming interface manager 1002 may present the template to the developer via another bot design programming interface, such that the developer can directly modify the template, e.g. by modifying some parameters, instead of selecting and building all modules of the virtual agent from beginning.

According to one embodiment of the present teaching, the bot design programming interface manager 1002 may provide another bot design programming interface to the developer, such that the developer input processor 1004 can receive and process one or more utterances input by the developer. Each of the input utterances, when entered by a chat user, can trigger a dialog between the virtual agent and the chat user.

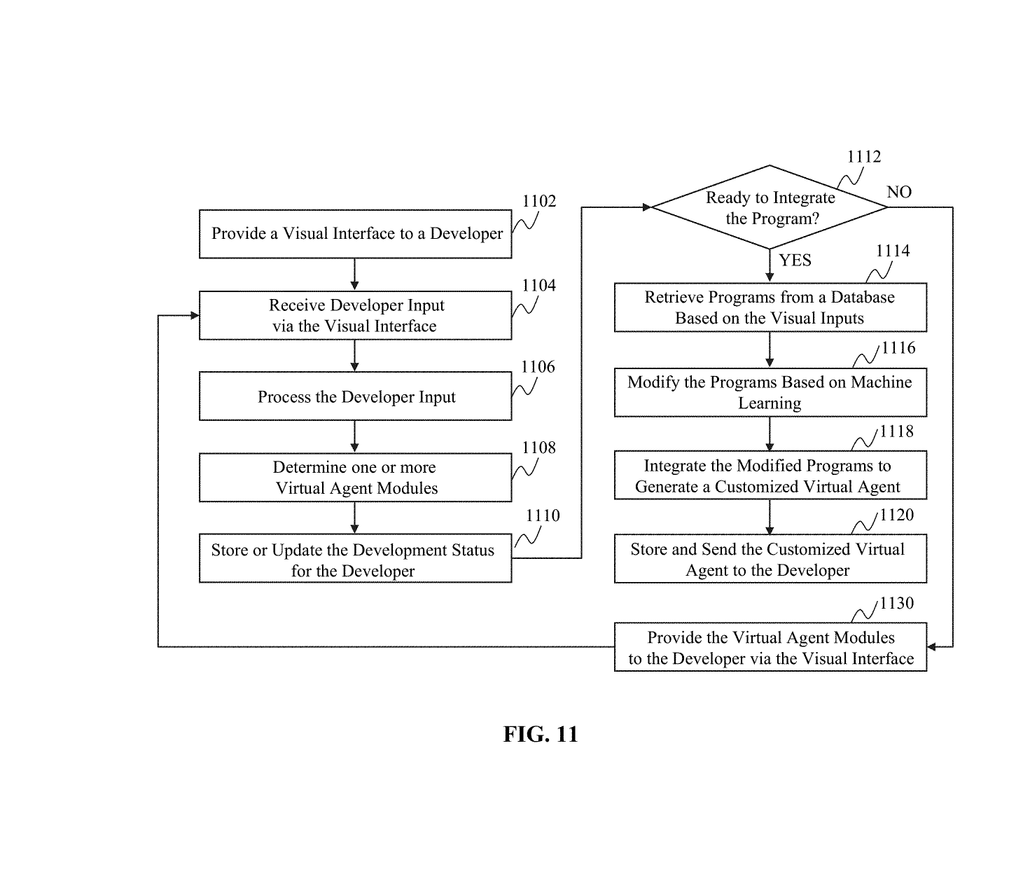

FIG. 11 is a flowchart of an exemplary process of a virtual agent development engine, e.g. the virtual agent development engine 170 in FIG. 10, according to an embodiment of the present teaching. A bot design programming interface is provided at 1102 to a developer. One or more inputs are received at 1104 from the developer via the bot design programming interface. The inputs are processed at 1106. One or more virtual agent modules are determined at 1108 based on the inputs. The development status of the virtual agent is stored or updated at 1110.

At 1112, it is determined whether it is ready to integrate the program to generate the customized virtual agent. If so, the process goes to 1114, where program source codes are retrieved from a database based on visual inputs and/or the determined modules. Then the program codes are modified at 1116 based on a machine learning model. The modified program codes are integrated at 1118 to generate a customized virtual agent. The customized virtual agent is stored and sent at 1120 to the developer.

If it is determined at 1112 that it is not ready to integrate the program, the process goes to 1130, wherein the virtual agent modules are provided to the developer via the bot design programming interface. Then the process goes back to 1104 to receive further developer inputs.

It can be understood that the order of the steps shown in FIGS. 3, 5, 7 and 11 may be changed according to different embodiments of the present teaching.

FIG. 12 illustrates an exemplary bot design programming interface 1200 for a developer to specify conditions for triggering a task oriented dialog between a service virtual agent and a chat user, according to an embodiment of the present teaching. As shown in FIG. 12, the developer may specify various conditions for triggering the task dialog with, e.g. a weather virtual agent. In this example, a weather virtual agent will be triggered when a chat user says any of the following utterances: (a) What's the weather? 1202; (b) What's the weather like in San Jose? 1204; (c) How's the weather in San Jose? 1206; and (d) Is it raining in Cupertino? 1208. As discussed herein, the virtual agent development engine 170 may utilize machine learning to generate more utterances similar to those exemplary utterances, such that when a chat user says anything similar to the list of automatically generated utterances, a task oriented virtual agent may be triggered to assist the chat user by initiating a dialog with the chat user. Each task oriented virtual agent may carry on a dialog for gather information needed to serve the chat user. For example, a weather bot, once triggered, may need to ask the chat user information related to parameters for checking whether, such as locale, date, or even time.

In some situations, a chat user may pose a question with some parameters already embedded in a specific utterance. For example, utterance (b) above “What's the weather like in San Jose?” (1204) includes both word “weather” which can be used to trigger a weather virtual agent and “San Jose” which is a parameter needed by the weather virtual agent in order to check weather related information. According to the present teaching, “San Jose” may be identified as a city name from the utterance. With this known parameter extracted from the utterance, the weather virtual agent, once triggered no longer has the need to ask the chat user about the city name any more. Similar situations exist with respect to utterances (c) “How's the weather in San Jose?” (1206); and (d) “Is it raining in Cupertino?” (1208). It can be understood that a developer can specify different utterances for triggering a task oriented virtual agent.

FIG. 13A illustrates an exemplary bot design programming interface 1300 for a developer to select modules of a service virtual agent, according to an embodiment of the present teaching. As shown in FIG. 13A, the disclosed system can present a plurality of bot design graphical programming objects 1311-1318 available to a developer, via the bot design programming interface 1300. Each of the plurality of bot design graphical programming objects represents a module corresponding to an action or a sub-task to be performed by the virtual agent. According to various embodiments of the present teaching, the bot design graphical programming object 1311 represents “Information Collection” module which, once executed, causes the underlying virtual agent to take an action to collect information (from a chat user) needed for performing the task that the virtual agent is designed to perform. For example, if a weather virtual agent is being programmed, the first task of the weather virtual agent is to gather information needed to check weather information, e.g., city. Bot design graphical programming object 1312 represents a sub-task of “bot says” module which, once executed, causes a virtual agent to speak or present some utterances to a chat user. Bot design graphical programming object 1313 represents a module which, when executed, causes the virtual agent to execute an application or a service associated with the task that the virtual agent is to do. For example, a travel virtual agent may invoke Travelocity.com (an existing application or service) to get flights information. Bot design graphical programming object 1314 represents a module which, when executed, causes the virtual agent to insert an existing task that was previously developed for a different virtual agent or the current virtual agent. Bot design graphical programming object 1315 represents a module which, when executed, causes the virtual agent to escalate the chat user to a human agent or to a different virtual agent in a different channel such as live chat, email, phone, text messages, etc. Bot design graphical programming object 1316 represents a module which, when executed, causes the virtual agent to finish one task when the virtual agent is developed to execute a plurality of tasks. One example for that can be the following. If a virtual agent is for travel and can do both airline and hotel reservations. The travel virtual agent is capable of handling multiple tasks, some of which may involve other specialized virtual agents, e.g., an air travel virtual agent and a hotel virtual agent. In this case, each sub-virtual agent may handle some sub tasks but they all try to achieve the same goal—making full reservations for a chat user. Both sub-agents may need to gather information which may share a module to do so, e.g., collect chat user's name, dates of traveling, source and destinations, etc. At some point, one sub-agent (e.g., the air travel sub-agent) may have completed all the sub-tasks related thereto, even though the other sub-agent (e.g., the hotel sub-agent) may still operating to get the chat user's hotel reservation. At this point, the developer user may utilize bot design programming graphical object 1316 to wrap up the sub-task related to air travel by, e.g., ending the operation of the air travel sub-agent. This may allow the virtual agent to run more efficiently. However, without this function to end some sub-tasks may not affect the functionality of the virtual agent.

Bot design graphical programming object 1317 represents a module which, when executed, causes the virtual agent to provide multiple options related to a parameter of a task or sub-task (e.g., if a chat user asks for means to travel to New York City, this module can be used to present “Travel by air or by bus?” and the answer to the question will allow the module to branch out to different sub-tasks). Bot design graphical programming object 1318 represents a module which, when executed, causes the virtual agent to execute a set of sub-modules or sub-tasks.

The developer can use such graphical bot design programming objects to quickly and efficiently program a virtual agent by arranging a sequence of actions to be performed by the virtual agent by simply dragging and dropping corresponding bot design graphical programming objects in a sequence. For example, as shown in FIG. 13A, the developer has selected a number of bot design graphical programming objects arranged in an order, i.e., a sequence of actions to be performed by the virtual bot currently being designed. In this example, the sequence of actions is represented by (1) action 1302 set up by dragging and dropping bot design graphical programming object 1311 to collect information, (2) action 1304 set up by dragging and dropping bot design graphical programming object 1312 for the virtual bot to speaks something to the chat user, (3) action 1306 set up by dragging and dropping bot design graphical programming object 1313 to invoke an action via a specific service (e.g., weather.com), and (4) action 1308 set up by dragging and dropping bot design graphical programming object 1312 for the virtual agent to speak to the chat user (e.g., report the weather information obtained from weather.com). This sequence of action correspond to a bot design with simple drag and drop activities to program the virtual bot with ease.

FIG. 13A illustrates an exemplary interface for development of a weather report virtual agent that can chat with any chat user about weather information. Specifically, the action of collecting information 1302, when executed, is to help to gather needed information from a chat user in order to provide the information the chat user is querying about. For example, the developer can make use of the collect information module 1302 to design how a chat bot is to collect information, e.g., the city to which a query about weather is directed.

FIG. 13B illustrates the exemplary bot design programming interface 1300 through which the developer can specify how a virtual agent can understand different ways to say the same thing. FIG. 13B corresponds to the same screen as what is shown in FIG. 13A but with a pull down list on to an answer to question “Which City?” In FIG. 13A, the answer to that question is “San Jose.” In FIG. 13B, a developer click on expand button 1332 (in FIG. 13A), which triggers a pull down list of different ways to answer “San Jose.” Once the expand button is clicked, the icon toggles to present a collapse button 1333 as shown in FIG. 13B. The developer may choose to add more alternatives to the list which can then be used by the virtual agent being programmed to understand an answer from a chat user. After the developer completes editing the list, the developer may click the collapse icon button 1333 to close the pull down list. As discussed before, the disclosed system deploys a deep learning model to identify an entity name from various sentences or text strings. In this example, although there are different ways to answer “San Jose” to a question on “Which city,” the deep learning model can be trained to recognize city name “San Jose” from all these various ways to say “San Jose.”

Referring back to FIG. 13A, the first “bot says” module 1304, when programmed into a virtual agent, allows the virtual agent to send an utterance to the chat user. For example, the developer can make use of the first “bot says” module 1304 to ask the chat user to be patient while the virtual agent is running some tasks. In this example, the weather virtual agent, after the chat user answers “San Jose,” the virtual agent may proceed to gather the weather information on San Jose and during that time, the weather virtual agent is programmed to use the first “bot says” module 1304 to let the chat user know the status by saying “Just a moment, searching for weather for you . . . ” In one embodiment, the developer may click the “add value” icon 1334 to enter a new utterance which can be used by the first “bot says” module 1304 as an alternative way to report the status to the chat user.

One such example is shown in FIG. 13C. FIG. 13C illustrates the exemplary bot design programming interface 1300 through which the developer may modify an existing utterance via the bot design programming interface to provide an alternative utterance for the first “bot says” module 1304 for the service virtual agent to be developed, according to an embodiment of the present teaching. As shown in FIG. 13C, the developer may click on the “Add value” icon 1334 (FIG. 13A) and enter an alternative utterance “The weather will be ready in a moment.” Once entered, the developer may click the icon 1335 for confirmation. In one embodiment, the confirmation may also be achieved when the developer hits the “enter” key on keyboard after entering the utterance. With the newly entered utterance, the first “bot says” module 1304, once being executed, may present the utterance to the chat user while the weather virtual agent is searching for the weather information for the city that the chat user specified.

Referring back to FIG. 13A, the application action module 1306, when executed, can invoke the virtual agent to execute an internal or external application or service. For example, the developer can make use of the application action module 1306 to interface with an external weather reporting service such as Yahoo! Weather to gather weather information for a specific city of a given date, or by running an embedded internal application, on weather related information gathering. In this example, based on chat user's input, the virtual agent may also generate warnings, e.g. a warning that city does not match with previous definition when the city provided by the chat user is not previously defined; or a warning that date has not been collected, when the virtual agent does not have the information about the date for the weather search.

It can be understood that a virtual agent may be programmed quickly with ease using the present teaching. Not only different modules may be used to program a virtual agent but also different virtual agents for the same task may be programmed using different sequences of modules. All may be done by easy drag and drop activities with possible additional editing to the parameters used by each module. A same module can be repeatedly used within a virtual agent, e.g. the first “bot says” module 1304 and the second “bot says” module 1308 in FIG. 13A. It can also be understood that, when the developer drags and drops a bot design graphical programming object to a specific position in a sequence in the bot design programming interface, the developer implicitly specifies an order for the modules in the sequence. For example, since the developer puts the first “bot says” module 1304 after the “collect information” module 1302 and before the application action module 1306, the first bot says module 1304 will be executed by the virtual agent after the “collect information” module 1302 and before the “application action” module 1306. As shown in FIG. 13A, each module has been listed according to the order when it will be executed by the virtual agent.

As shown in FIG. 13A, although a module may be executed without any condition (or unconditionally), the developer may also set a condition under which the module is to be executed. For example, as shown, the developer may set a condition for executing the application action module 1306, e.g., the application action module 1306 will only be executed when all parameters, e.g. city, date, etc. have been collected from the chat user. In another example, the developer may set a condition that an action to escalate a chat user to a human agent via an escalation module until the conversation with the chat user is involved with a price that is higher than a threshold or when the chat user is detected to be dissatisfied with the virtual agent.

In one embodiment, the disclosed system can present a button “Chat with Virtual Assistant” 1320 on the bot design programming interface. In this example, once the developer clicks on the button 1320, the disclosed system may allow the developer to test the virtual agent just programmed in accordance with the sequence of modules (put together by drag and drop various bot design graphical programming objects) by starting a dialog with the programmed virtual agent. With this functionality, the developer may program, test, and modify the virtual agent repeatedly until the virtual agent can be deployed as a functionally customized virtual agent.

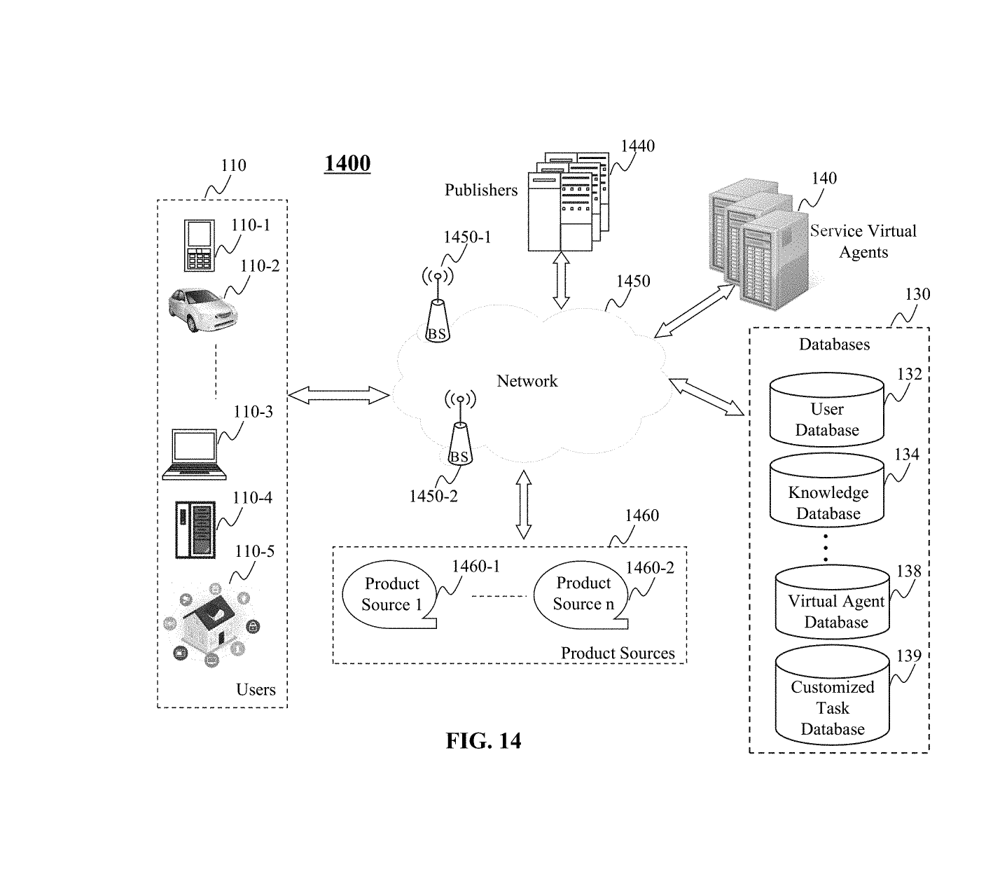

FIG. 14 is a high level depiction of an exemplary networked environment 1400 for development and applications of service virtual agents, according to an embodiment of the present teaching. In this exemplary networked environment 1400, user 110 may be connected to a publisher 1440 via the network 1450. There are additional product sources 1460 where a plurality of products sources 1460-1 . . . 1460-2 that the user may be connected to and be able to search for products via conversations with the service virtual agents 140 as disclosed herein. A user can be operating from different platforms and in different type of environment such as on a smart device 110-1, in a car 110-2, on a laptop 110-3, on a desktop 110-4 . . . , or from a smart home 110-5. The network 1450 may include wired and wireless networks, including but not limited to, cellular network, wireless network, Bluetooth network, Public Switched Telephone Network (PSTN), the Internet, or any combination thereof. For example, a user device may be wirelessly connected via Bluetooth to a cellular network, which may subsequently be connected to a PSTN, and then reach to the Internet. The network 1450 may also include a local network (not shown), including a LAN or anything that is set up to serve equivalent functions.

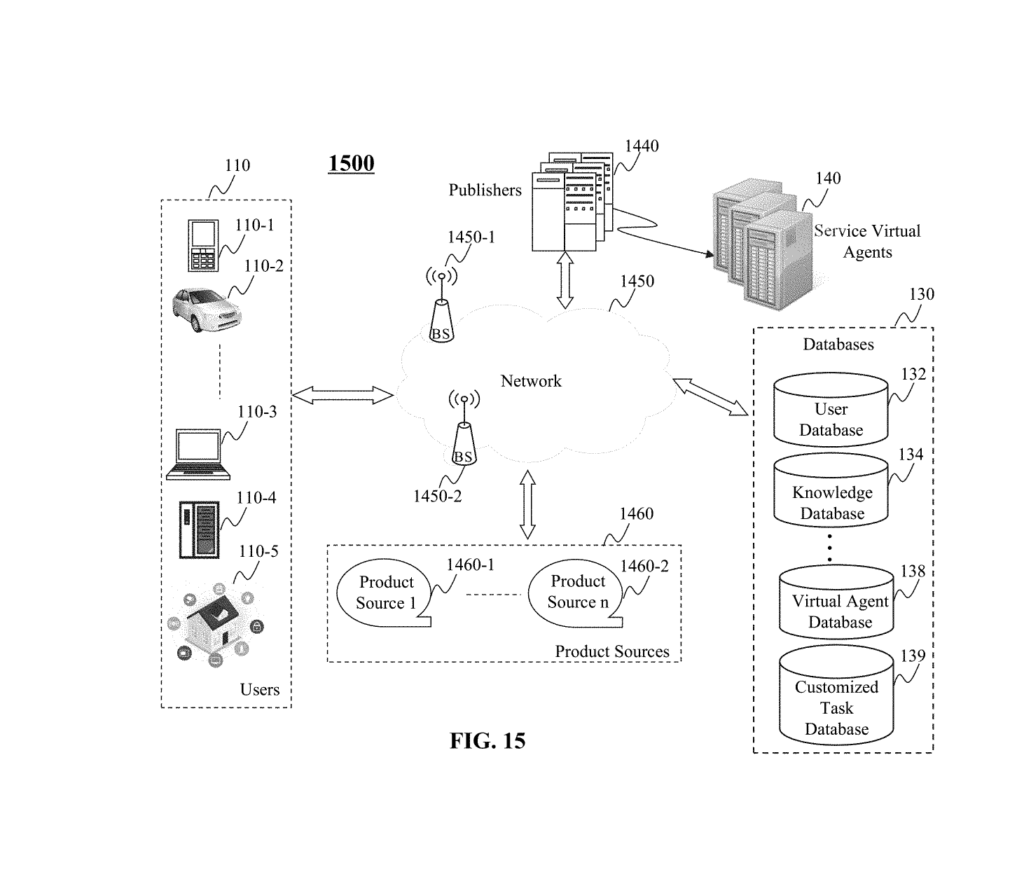

In FIG. 14, each of the service virtual agents 140 are connected to the network 1450 to provide the functionalities as described herein, either independently as a standalone service, as depicted in FIG. 14, or as a backend service provider connected to the publisher 1440 as shown in FIG. 15 or to any of the product sources (not shown) as a backend specialized functioning support for the product source. Various databases 130 (including but not limited to a user database 132, a knowledge database 134, a virtual agent database 138, . . . , and a customized task database 139) may also be made available, either as independent sources of information as shown in FIGS. 14 and 15 or as backend databased in association with the service virtual agents 140 (not shown).

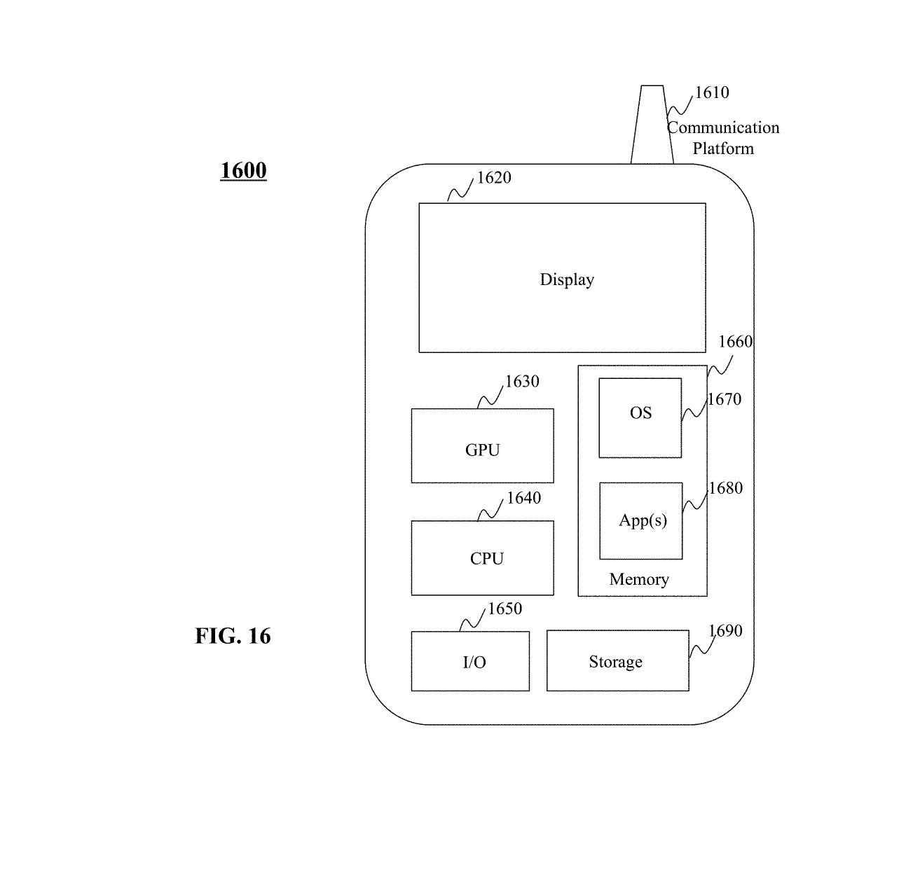

FIG. 16 depicts the architecture of a mobile device which can be used to realize a specialized system implementing the present teaching. This mobile device 1600 includes, but is not limited to, a smart phone, a tablet, a music player, a handled gaming console, a global positioning system (GPS) receiver, and a wearable computing device (e.g., eyeglasses, wrist watch, etc.), or in any other form factor. The mobile device 1600 in this example includes one or more central processing units (CPUs) 1640, one or more graphic processing units (GPUs) 1630, a display 1620, a memory 1660, a communication platform 1610, such as a wireless communication module, storage 1690, and one or more input/output (I/O) devices 1650. Any other suitable component, including but not limited to a system bus or a controller (not shown), may also be included in the mobile device 1600. As shown in FIG. 16, a mobile operating system 1670, e.g., iOS, Android, Windows Phone, etc., and one or more applications 1680 may be loaded into the memory 1660 from the storage 1690 in order to be executed by the CPU 1640.

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to the present teachings as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

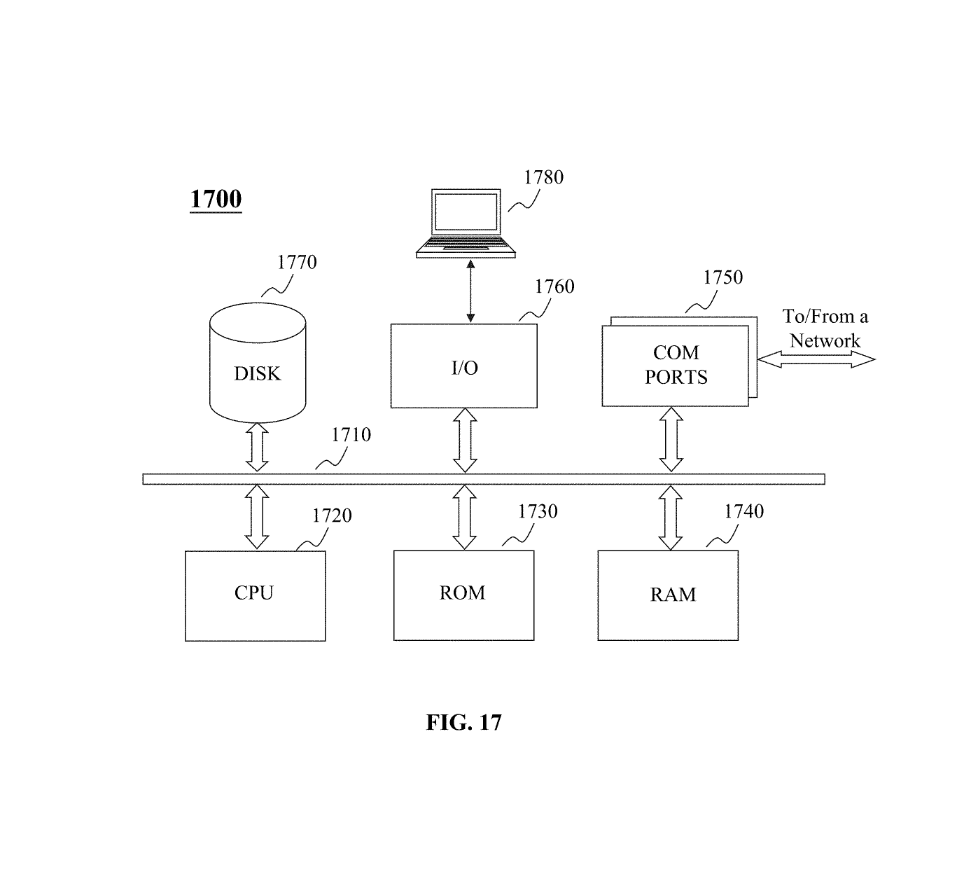

FIG. 17 depicts the architecture of a computing device which can be used to realize a specialized system implementing the present teaching. Such a specialized system incorporating the present teaching has a functional block diagram illustration of a hardware platform which includes user interface elements. The computer may be a general purpose computer or a special purpose computer. Both can be used to implement a specialized system for the present teaching. This computer 1700 may be used to implement any component of the present teachings, as described herein. Although only one such computer is shown, for convenience, the computer functions relating to the present teachings as described herein may be implemented in a distributed fashion on a number of similar platforms, to distribute the processing load.

The computer 1700, for example, includes COM ports 1750 connected to and from a network connected thereto to facilitate data communications. The computer 1700 also includes a central processing unit (CPU) 1720, in the form of one or more processors, for executing program instructions. The exemplary computer platform includes an internal communication bus 1710, program storage and data storage of different forms, e.g., disk 1770, read only memory (ROM) 1730, or random access memory (RAM) 1740, for various data files to be processed and/or communicated by the computer, as well as possibly program instructions to be executed by the CPU. The computer 1700 also includes an I/O component 1760, supporting input/output flows between the computer and other components therein such as user interface element. The computer 1700 may also receive programming and data via network communications.

Hence, aspects of the methods of the present teachings, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer of a search engine operator or other enhanced ad server into the hardware platform(s) of a computing environment or other system implementing a computing environment or similar functionalities in connection with the present teachings. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution—e.g., an installation on an existing server. In addition, the present teachings as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on a computer having at least one processor, a storage, and a communication platform for automatic re-routing a chat user, comprising:
receiving a request for re-routing the chat user, currently engaged in a dialog involving a first agent, to a second agent, wherein the request comprises relevant information and context of the dialog that gives rise to the re-routing request;
determining automatically a re-routing strategy based on the relevant information and the context of the dialog, wherein the re-routing strategy is determined in accordance with re-routing configurations;
selecting the second agent based on the re-routing strategy; and
re-routing the chat user to the selected different agent to continue the dialog.

2. The method of claim 1, wherein the relevant information includes
one or more re-routing parameters indicative of at least a requirement of the second agent;
data related to the dialog the chat user is involved in.

3. The method of claim 1, wherein the re-routing strategy is determined further based on a preference specified with respect to a customer that deployed the virtual agent, wherein the preference indicates whether re-routing the chat user to a different virtual agent is preferred.

4. The method of claim 1, wherein the second agent includes
a human agent; and
a virtual agent.

5. The method of claim 4, wherein the selecting the second agent comprises:
selecting a human agent as the second agent if the re-routing strategy indicates to re-route the chat user to a human agent; and
selecting a virtual agent as the second agent if the re-routing strategy indicates to re-route the chat user to a virtual agent.

6. The method of claim 5, wherein the selecting a virtual agent comprises:
comparing a profile of each of a plurality of virtual agents available for re-routing with the relevant information associated with the re-routing request;
identifying one of the plurality of virtual agent as the second agent based on a result from the comparing.

7. The method of claim 2, wherein
the relevant information associated with the re-routing request is indicative of a domain of expertise needed for the second agent;
a profile for each of the plurality of virtual agents available for re-routing is indicative of a domain of expertise the virtual agent is in.

8. Machine readable non-transitory medium having information recorded thereon for automatic re-routing a chat user, wherein the information, when read by the machine, causes the machine to perform the following:
receiving a request for re-routing the chat user, currently engaged in a dialog involving a first agent, to a second agent, wherein the request comprises relevant information and context of the dialog that gives rise to the re-routing request;
determining automatically a re-routing strategy based on the relevant information and the context of the dialog, wherein the re-routing strategy is determined in accordance with re-routing configurations;
selecting the second agent based on the re-routing strategy; and
re-routing the chat user to the selected different agent to continue the dialog.

9. The medium of claim 8, wherein the relevant information includes
one or more re-routing parameters indicative of at least a requirement of the second agent;
data related to the dialog the chat user is involved in.

10. The medium of claim 8, wherein the re-routing strategy is determined further based on a preference specified with respect to a customer that deployed the virtual agent, wherein the preference indicates whether re-routing the chat user to a different virtual agent is preferred.

11. The medium of claim 8, wherein the second agent includes
a human agent; and
a virtual agent.

12. The medium of claim 11, wherein the selecting the second agent comprises:
selecting a human agent as the second agent if the re-routing strategy indicates to re-route the chat user to a human agent; and
selecting a virtual agent as the second agent if the re-routing strategy indicates to re-route the chat user to a virtual agent.

13. The medium of claim 12, wherein the selecting a virtual agent comprises:
comparing a profile of each of a plurality of virtual agents available for re-routing with the relevant information associated with the re-routing request;
identifying one of the plurality of virtual agent as the second agent based on a result from the comparing.

14. The method of claim 9, wherein
the relevant information associated with the re-routing request is indicative of a domain of expertise needed for the second agent;
a profile for each of the plurality of virtual agents available for re-routing is indicative of a domain of expertise the virtual agent is in.

15. A system for automatic re-routing a chat user, comprising:
a re-routing information analyzer configured for analyzing a request for re-routing the chat user, currently engaged in a dialog involving a first agent, to a second agent, wherein the request comprises relevant information and context of the dialog that gives rise to the re-routing request;
a re-routing strategy selector configured for
determining automatically a re-routing strategy based on the relevant information and the context of the dialog, wherein the re-routing strategy is determined in accordance with re-routing configurations, and
selecting the second agent based on the re-routing strategy; and
an agent re-routing controller configured for re-routing the chat user to the selected different agent to continue the dialog.

16. The system of claim 15, wherein the relevant information includes
one or more re-routing parameters indicative of at least a requirement of the second agent;
data related to the dialog the chat user is involved in.

17. The system of claim 15, wherein the re-routing strategy is determined further based on a preference specified with respect to a customer that deployed the virtual agent, wherein the preference indicates whether re-routing the chat user to a different virtual agent is preferred.

18. The system of claim 15, wherein the second agent includes
a human agent; and
a virtual agent.

19. The system of claim 18, wherein the re-routing strategy selector comprises:
a re-routing target determiner configured for determining whether the chat user is to be re-routed to a human or a virtual agent as the second agent;
a human agent selector configured for selecting a human agent as the second agent if the re-routing target is determined to be a human agent; and
a virtual agent profile matching unit configured for identifying a virtual agent as the second agent if the re-routing target is determined to be a virtual agent.

20. The system of claim 19, wherein the virtual agent profile matching unit is further configured for:
comparing a profile of each of a plurality of virtual agents available for re-routing with the relevant information associated with the re-routing request;
selecting one of the plurality of virtual agent as the second agent based on a result from the comparing.

21. The system of claim 16, wherein
the relevant information associated with the re-routing request is indicative of a domain of expertise needed for the second agent;
a profile for each of the plurality of virtual agents available for re-routing is indicative of a domain of expertise the virtual agent is in.
